(19) United States
(12) Patent Application Publication
(10) Pub. No.: US 2018/0332328 A1
(43) Pub. Date: Nov. 15, 2018

(54) Method and System for Implementing Conflict Resolution for Electronic Program Guides

(71) Applicant: CenturyLink Intellectual Property LLC, Denver, CO (US)

(72) Inventors: Michael D. Sprenger, Boulder, CO (US); Zubin Ingah, Centennial, CO (US); Aamir Hussain, Monroe, LA (US); Fernando Prieto-Ochoa, Denver, CO (US); Asghar Hussain, Parker, CO (US)

(21) Appl. No.: 15/840,982

(22) Filed: Dec. 13, 2017

Related U.S. Application Data
(60) Provisional application No. 62/503,403, filed on May 9, 2017.
(60) Provisional application No. 62/512,413, filed on May 30, 2017.

(51) Int. Cl. H04N 21/262; H04N 21/235; H04N 21/234; H04N 21/482

(52) U.S. Cl. CPC H04N 21/26283; H04N 21/4821; H04N 21/23418; H04N 21/235

(57) ABSTRACT

Novel tools and techniques are provided for implementing conflict resolution for electronic program guides. In various embodiments, a computing system might receive a plurality of metadata each from a metadata source among a plurality of metadata sources, each of the metadata corresponding to a video content, might compile the plurality of metadata, might determine whether at least one metadata of the plurality of metadata is inconsistent with other metadata of the plurality of metadata. Based on a determination that at least one metadata is inconsistent with other metadata, the computing system might analyze the plurality of metadata to determine which set of metadata more accurately corresponds to the video content, might modify one or more metadata based on such determination, might generate an EPG that presents the video content, using metadata consistent with the modified one or more metadata, and might display the EPG on a display device.

### CROSS-REFERENCES TO RELATED APPLICATIONS

This application claims priority to U.S. Patent Application Ser. No. 62/503,403 (the “'403 Application”), filed May 9, 2017 by Zubin Ingah et al. (Attorney Docket No. 020370-033501US), entitled, “Unified Multi-Source Video Programming & Navigation Guide,” and U.S. Patent Application Ser. No. 62/512,413 (the “'413 Application”), filed May 30, 2017 by Michael D. Sprenger et al. (Attorney Docket No. 020370-033901US), entitled, “Conflict Resolution Mechanism for Electronic Program Guides,” the disclosure of each of which is incorporated herein by reference in its entirety for all purposes.

This application may be related to U.S. patent application Ser. No. 15/840,770 (the “'770 Application”), filed concurrent herewith (Attorney Docket No. 020370-033500US), entitled, “Method and System for Implementing Unified Multi-Source Video Programming & Navigation Guide,” which also claims priority to the '403 and '413 Applications.

The respective disclosures of these applications/patents (which this document refers to collectively as the “Related Applications”) are incorporated herein by reference in their entirety for all purposes.

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### FIELD

The present disclosure relates, in general, to methods, systems, and apparatuses for implementing media content navigation and presentation, and, more particularly, to methods, systems, and apparatuses for implementing conflict resolution for electronic program guides.

### BACKGROUND

Electronic program guides (“EPGs”) that are used for Internet Protocol television (“IPTV”), cable TV, satellite TV, over the top video services, and/or other forms of streaming media often obtain their programming metadata from multiple sources. Such metadata may have gaps or may not always be consistent across multiple providers.

Hence, there is a need for more robust and scalable solutions for implementing media content navigation and presentation, and, more particularly, to methods, systems, and apparatuses for implementing conflict resolution for electronic program guides.

### BRIEF DESCRIPTION OF THE DRAWINGS

A further understanding of the nature and advantages of particular embodiments may be realized by reference to the remaining portions of the specification and the drawings, in which like reference numerals are used to refer to similar components. In some instances, a sub-label is associated with a reference numeral to denote one of multiple similar components. When reference is made to a reference numeral without specification to an existing sub-label, it is intended to refer to all such multiple similar components.

FIG. 1 is a schematic diagram illustrating a system for implementing conflict resolution for electronic program guides, in accordance with various embodiments.

FIG. 2 is a schematic diagram illustrating another system for implementing conflict resolution for electronic program guides, in accordance with various embodiments.

FIGS. 3A-3D are schematic diagrams illustrating various embodiments of user interfaces and display screens depicting electronic program guides having conflicts or other errors to be corrected when implementing conflict resolution for electronic program guides.

FIGS. 4A-4E are flow diagrams illustrating a method for implementing conflict resolution for electronic program guides, in accordance with various embodiments.

FIG. 5 is a block diagram illustrating an exemplary computer or system hardware architecture, in accordance with various embodiments.

FIG. 6 is a block diagram illustrating a networked system of computers, computing systems, or system hardware architecture, which can be used in accordance with various embodiments.

### DETAILED DESCRIPTION OF CERTAIN EMBODIMENTS

### Overview

Various embodiments provide tools and techniques for implementing media content navigation and presentation, and, more particularly, to methods, systems, and apparatuses for implementing conflict resolution for electronic program guides.

In various embodiments, a computing system (which in some cases may be embodied by an electronic program guide (“EPG”), a metadata server, a set-top box (“STB”), or the like) might receive a plurality of first metadata each from a metadata source among a plurality of metadata sources, each of the first metadata corresponding to first video content among a plurality of video content. The computing system might also compile the plurality of first metadata from the plurality of metadata sources. The computing system might further determine whether at least one first metadata of the plurality of first metadata is inconsistent with other first metadata of the plurality of first metadata. Based on a determination that at least one first metadata of the plurality of first metadata is inconsistent with other first metadata of the plurality of first metadata, the computing system might analyze the plurality of first metadata to determine which set of first metadata more accurately corresponds to the first video content, might modify one or more of the plurality of first metadata based on which set of first metadata is determined to more accurately correspond to the first video content, might generate an EPG that presents the first video content in a list, using first metadata consistent with the modified one or more of the plurality of first metadata, and might display the EPG on the display screen of the display device.

In some embodiments, the computing system might comprise one of an EPG system, a metadata server, a set-top box (“STB”), a digital video recording (“DVR”) device, a processor of the display device running a software application (“app”), a processor of a user device running an app, a server computer over a network, a cloud-based computing system over a network, a media player, or a gaming console, and/or the like. In some cases, the display device might comprise one of a television set, a smart television, a computer monitor, a laptop monitor, or a projection system, and/or the like. In some instances, the first video content might be available from a plurality of video content sources, each comprising one of a video streaming source, a video broadcast source, an off the air (“OTA”) source, or a third party video content source, and/or the like. In some cases, each of the plurality of first metadata might be received by the computing system in response to one of a pull data distribution instruction, a push data distribution instruction, or a hybrid push-pull data distribution instruction, and/or the like.

According to some embodiments, determining whether at least one first metadata of the plurality of first metadata is inconsistent with other first metadata of the plurality of first metadata and analyzing the plurality of first metadata to determine which set of first metadata more accurately corresponds to the first video content might comprise using one of a voting scheme technique, a metadata provider ranking technique, a self-learning adaptive technique, an image recognition technique, an audio recognition technique, a video recognition technique, or a combination of these techniques, and/or the like.

The various embodiments describe a mechanism to resolve such inconsistencies. It enables an operator or provider of video, audio, or similar types of services to provide to consumers EPGs with higher confidence of containing correct information. Examples of typical metadata might include, without limitation, channel name, channel number, start time, duration, content type or category, rating and similar kinds of information, and/or the like. Not all of the metadata fields are applicable to all content types. Fields not applicable to a specific piece of content are typically left unpopulated or assigned an empty string, null, or dummy value. Given the large amount of metadata potentially associated with a content title, it is understandable that fields can be populated with an incorrect value or none at all, due to errors or incomplete information. Also, some providers may simply not have all or complete metadata available for a given piece of content. Various aspects are able to handle inconsistent and/or missing metadata, and might resolve metadata conflicts among multiple providers.

The following detailed description illustrates a few exemplary embodiments in further detail to enable one of skill in the art to practice such embodiments. The described examples are provided for illustrative purposes and are not intended to limit the scope of the invention.

In the following description, for the purposes of explanation, numerous specific details are set forth in order to provide a thorough understanding of the described embodiments. It will be apparent to one skilled in the art, however, that other embodiments of the present invention may be practiced without some of these specific details. In other instances, certain structures and devices are shown in block diagram form. Several embodiments are described herein, and while various features are ascribed to different embodiments, it should be appreciated that the features described with respect to one embodiment may be incorporated with other embodiments as well. By the same token, however, no single feature or features of any described embodiment should be considered essential to every embodiment of the invention, as other embodiments of the invention may omit such features.

Unless otherwise indicated, all numbers used herein to express quantities, dimensions, and so forth used should be understood as being modified in all instances by the term “about.” In this application, the use of the singular includes the plural unless specifically stated otherwise, and use of the terms “and” and “or” means “and/or” unless otherwise indicated. Moreover, the use of the term “including,” as well as other forms, such as “includes” and “included,” should be considered non-exclusive. Also, terms such as “element” or “component” encompass both elements and components comprising one unit and elements and components that comprise more than one unit, unless specifically stated otherwise.

Various embodiments described herein, while embodying (in some cases) software products, computer-performed methods, and/or computer systems, represent tangible, concrete improvements to existing technological areas, including, without limitation, media content streaming or downloading technology, media content navigation or selection technology, user interface technology, and/or the like. In other aspects, certain embodiments, can improve the functioning of user equipment or systems themselves (e.g., media players, set-top boxes (“STBs”), media content streaming or downloading systems, etc.), for example, by receiving, with a computing system, a plurality of first metadata each from a metadata source among a plurality of metadata sources, each of the first metadata corresponding to first video content among a plurality of video content; compiling, with the computing system, the plurality of first metadata from the plurality of metadata sources; determining, with the computing system, whether at least one first metadata of the plurality of first metadata is inconsistent with other first metadata of the plurality of first metadata; based on a determination that at least one first metadata of the plurality of first metadata is inconsistent with other first metadata of the plurality of first metadata, analyzing, with the computing system, the plurality of first metadata to determine which set of first metadata more accurately corresponds to the first video content; modifying, with the computing system, one or more of the plurality of first metadata based on which set of first metadata is determined to more accurately correspond to the first video content; generating, with the computing system, an electronic program guide (“EPG”) that presents the first video content in a list, using first metadata consistent with the modified one or more of the plurality of first metadata; and displaying, with the computing system, the EPG on a display device; and/or the like. In particular, to the extent any abstract concepts are present in the various embodiments, those concepts can be implemented as described herein by devices, software, systems, and methods that involve specific novel functionality (e.g., steps or operations), such as, based on a determination that at least one first metadata of the plurality of first metadata is inconsistent with other first metadata of the plurality of first metadata, analyzing, with the computing system, the plurality of first metadata to determine which set of first metadata more accurately corresponds to the first video content; modifying, with the computing system, one or more of the plurality of first metadata based on which set of first metadata is determined to more accurately correspond to the first video content; and generating, with the computing system, an EPG that presents the first video content in a list, using first metadata consistent with the modified one or more of the plurality of first metadata; and/or the like, which optimizes presentation and navigation of the media content (particularly video content) thus providing for more accurate and up-to-date EPG, and/or the like, to name a few examples, that extend beyond mere conventional computer processing operations. These functionalities can produce tangible results outside of the implementing computer system, including, merely by way of example, optimized EPG that provides accurate and up-to-date information regarding video content listed in the EPG, and/or the like, at least some of which may be observed or measured by customers and/or service providers.

In an aspect, a method might comprise receiving, with a computing system, a plurality of first metadata each from a metadata source among a plurality of metadata sources, each of the first metadata corresponding to first video content among a plurality of video content; compiling, with the computing system, the plurality of first metadata from the plurality of metadata sources; and determining, with the computing system, whether at least one first metadata of the plurality of first metadata is inconsistent with other first metadata of the plurality of first metadata. The method might also comprise, based on a determination that at least one first metadata of the plurality of first metadata is inconsistent with other first metadata of the plurality of first metadata, analyzing, with the computing system, the plurality of first metadata to determine which set of first metadata more accurately corresponds to the first video content; modifying, with the computing system, one or more of the plurality of first metadata based on which set of first metadata is determined to more accurately correspond to the first video content; and generating, with the computing system, an electronic program guide (“EPG”) that presents the first video content in a list, using first metadata consistent with the modified one or more of the plurality of first metadata. The method might further comprise displaying, with the computing system, the EPG on a display device.

In some embodiments, the computing system might comprise one of an EPG system, a metadata server, a set-top box (“STB”), a digital video recording (“DVR”) device, a processor of the display device running a software application (“app”), a processor of a user device running an app, a server computer over a network, a cloud-based computing system over a network, a media player, or a gaming console, and/or the like. In some cases, the display device might comprise one of a television set, a smart television, a computer monitor, a laptop monitor, or a projection system, and/or the like. In some instances, the first video content might be available from a plurality of video content sources, each comprising one of a video streaming source, a video broadcast source, an off the air (“OTA”) source, or a third party video content source, and/or the like. In some cases, each of the plurality of first metadata might be received by the computing system in response to one of a pull data distribution instruction, a push data distribution instruction, or a hybrid push-pull data distribution instruction, and/or the like.

According to some embodiments, determining whether at least one first metadata of the plurality of first metadata is inconsistent with other first metadata of the plurality of first metadata and analyzing the plurality of first metadata to determine which set of first metadata more accurately corresponds to the first video content might comprise using one of a voting scheme technique, a metadata provider ranking technique, a self-learning adaptive technique, an image recognition technique, an audio recognition technique, a video recognition technique, or a combination of these techniques, and/or the like.

In some cases, determining whether at least one first metadata of the plurality of first metadata is inconsistent with other first metadata of the plurality of first metadata and analyzing the plurality of first metadata to determine which set of first metadata more accurately corresponds to the first video content might comprise: identifying, with the computing system, which one or more portions of the plurality of first metadata are inconsistent with corresponding one or more portions of the plurality of first metadata; determining, with the computing system, whether the identified one or more portions of the plurality of first metadata represent a majority over the corresponding one or more portions of the plurality of first metadata; based on a determination that the identified one or more portions of the plurality of first metadata represent a majority over the corresponding one or more portions of the plurality of first metadata, designating, with the computing system, the identified one or more portions of the plurality of first metadata as more accurately corresponding to the first video content; and based on a determination that the corresponding one or more portions of the plurality of first metadata represent a majority over the identified one or more portions of the plurality of first metadata, designating, with the computing system, the corresponding one or more portions of the plurality of first metadata as more accurately corresponding to the first video content.

In some instances, each of the plurality of first metadata might comprise an accuracy counter value associated with corresponding one of the plurality of metadata sources, the accuracy counter value indicating a level of accuracy that each of the plurality of metadata sources has with respect to the first metadata. In such cases, determining whether at least one first metadata of the plurality of first metadata is inconsistent with other first metadata of the plurality of first metadata and analyzing the plurality of first metadata to determine which set of first metadata more accurately corresponds to the first video content might comprise: identifying, with the computing system, a metadata source among the plurality of metadata sources that is associated with the highest accuracy counter value; and designating, with the computing system, the first metadata among the plurality of first metadata corresponding to the identified metadata source as more accurately corresponding to the first video content. In some cases, the method might further comprise incrementing, with the computing system, the accuracy counter value of the designated first metadata corresponding to the identified metadata source as more accurately corresponding to the first video content. In some instances, the method might further comprise decrementing, with the computing system, the accuracy counter value of first metadata corresponding to a metadata source providing first metadata deemed to be inconsistent with other first metadata of the plurality of first metadata.

According to some embodiments, the method might further comprise determining, with the computing system, accuracy of first metadata associated with at least one metadata source of the plurality of metadata sources over a predetermined period of time. The method might further comprise, based on a determination that the first metadata associated with the at least one metadata source is accurate for at least a predetermined threshold percentage of instances over the predetermined period of time, incrementing, with the computing system, the accuracy counter value of the first metadata associated with the at least one metadata source. The method might further comprise, based on a determination that the first metadata associated with the at least one metadata source is not accurate for at least the predetermined threshold percentage of instances over the predetermined period of time, decrementing, with the computing system, the accuracy counter value of the first metadata associated with the at least one metadata source.

In some embodiments, determining whether at least one first metadata of the plurality of first metadata is inconsistent with other first metadata of the plurality of first metadata and analyzing the plurality of first metadata to determine which set of first metadata more accurately corresponds to the first video content might comprise: analyzing, with the computing system, at least portions of the first video content using at least one of image recognition techniques, audio recognition techniques, or video recognition techniques to identify content information related to the first metadata; determining, with the computing system, whether the first metadata associated with at least one metadata source is consistent with the identified content information; based on a determination that the first metadata associated with the at least one metadata source is consistent with the identified content information, designating, with the computing system, the first metadata associated with the at least one metadata source as more accurately corresponding to the first video content; and based on a determination that the first metadata associated with the at least one metadata source is not consistent with the identified content information, designating, with the computing system, the first metadata associated with the at least one metadata source as less accurately corresponding to the first video content.

Merely by way of example, in some cases, the identified content information might be based on at least one of logos or symbols associated with the first video content, music associated with the first video content, news personalities associated with the first video content, actors or actresses associated with the first video content, characters associated with the first video content, scenes associated with the first video content, phrases associated with the first video content, credits associated with the first video content, logos or symbols associated with a video content source associated with the first video content, music associated with the video content source associated with the first video content, news personalities associated with the video content source associated with the first video content, actors or actresses associated with the video content source associated with the first video content, characters associated with the video content source associated with the first video content, phrases associated with the video content source associated with the first video content, or credits associated with the video content source associated with the first video content, and/or the like.

In another aspect, an apparatus might comprise at least one processor and a non-transitory computer readable medium communicatively coupled to the at least one processor. The non-transitory computer readable medium might have stored thereon computer software comprising a set of instructions that, when executed by the at least one processor, causes the apparatus to: receive a plurality of first metadata each from a metadata source among a plurality of metadata sources, each of the first metadata corresponding to first video content among a plurality of video content; compile the plurality of first metadata from the plurality of metadata sources; determine whether at least one first metadata of the plurality of first metadata is inconsistent with other first metadata of the plurality of first metadata; based on a determination that at least one first metadata of the plurality of first metadata is inconsistent with other first metadata of the plurality of first metadata, analyze the plurality of first metadata to determine which set of first metadata more accurately corresponds to the first video content; modify one or more of the plurality of first metadata based on which set of first metadata is determined to more accurately correspond to the first video content; generate an electronic program guide (“EPG”) that presents the first video content in a list, using first metadata consistent with the modified one or more of the plurality of first metadata; and display the EPG on a display device.

According to some embodiments, the apparatus might comprise one of an EPG system, a metadata server, a set-top box (“STB”), a digital video recording (“DVR”) device, a processor of the display device running a software application (“app”), a processor of a user device running an app, a server computer over a network, a cloud-based computing system over a network, a media player, or a gaming console, and/or the like. In some cases, the display device might comprise one of a television set, a smart television, a computer monitor, a laptop monitor, or a projection system, and/or the like. In some instances, the first video content might be available from a plurality of video content sources, each comprising one of a video streaming source, a video broadcast source, an off the air (“OTA”) source, or a third party video content source, and/or the like. In some cases, each of the plurality of first metadata might be received by the computing system in response to one of a pull data distribution instruction, a push data distribution instruction, or a hybrid push-pull data distribution instruction, and/or the like.

In some embodiments, determining whether at least one first metadata of the plurality of first metadata is inconsistent with other first metadata of the plurality of first metadata and analyzing the plurality of first metadata to determine which set of first metadata more accurately corresponds to the first video content might comprise using one of a voting scheme technique, a metadata provider ranking technique, a self-learning adaptive technique, an image recognition technique, an audio recognition technique, a video recognition technique, or a combination of these techniques, and/or the like.

In yet another aspect, a system might comprise a computing system and a display device. The computing system might comprise at least one first processor and a first non-transitory computer readable medium communicatively coupled to the at least one first processor. The first non-transitory computer readable medium might have stored thereon computer software comprising a first set of instructions that, when executed by the at least one first processor, causes the computing system to: receive a plurality of first metadata each from a metadata source among a plurality of metadata sources, each of the first metadata corresponding to first video content among a plurality of video content; compile the plurality of first metadata from the plurality of metadata sources; determine whether at least one first metadata of the plurality of first metadata is inconsistent with other first metadata of the plurality of first metadata; based on a determination that at least one first metadata of the plurality of first metadata is inconsistent with other first metadata of the plurality of first metadata, analyze the plurality of first metadata to determine which set of first metadata more accurately corresponds to the first video content; modify one or more of the plurality of first metadata based on which set of first metadata is determined to more accurately correspond to the first video content; generate an electronic program guide (“EPG”) that presents the first video content in a list, using first metadata consistent with the modified one or more of the plurality of first metadata; and send the EPG to the display device.

The display device might comprise a display screen; at least one second processor; and a second non-transitory computer readable medium communicatively coupled to the at least one second processor. The second non-transitory computer readable medium might have stored thereon computer software comprising a second set of instructions that, when executed by the at least one second processor, causes the display device to: receive the EPG from the computing system; and display the EPG on the display screen.

In some embodiments, the computing system might comprise one of an EPG system, a metadata server, a set-top box (“STB”), a digital video recording (“DVR”) device, a processor of the display device running a software application (“app”), a processor of a user device running an app, a server computer over a network, a cloud-based computing system over a network, a media player, or a gaming console, and/or the like.

Various modifications and additions can be made to the embodiments discussed without departing from the scope of the invention. For example, while the embodiments described above refer to particular features, the scope of this invention also includes embodiments having different combination of features and embodiments that do not include all of the above described features.

### Specific Exemplary Embodiments

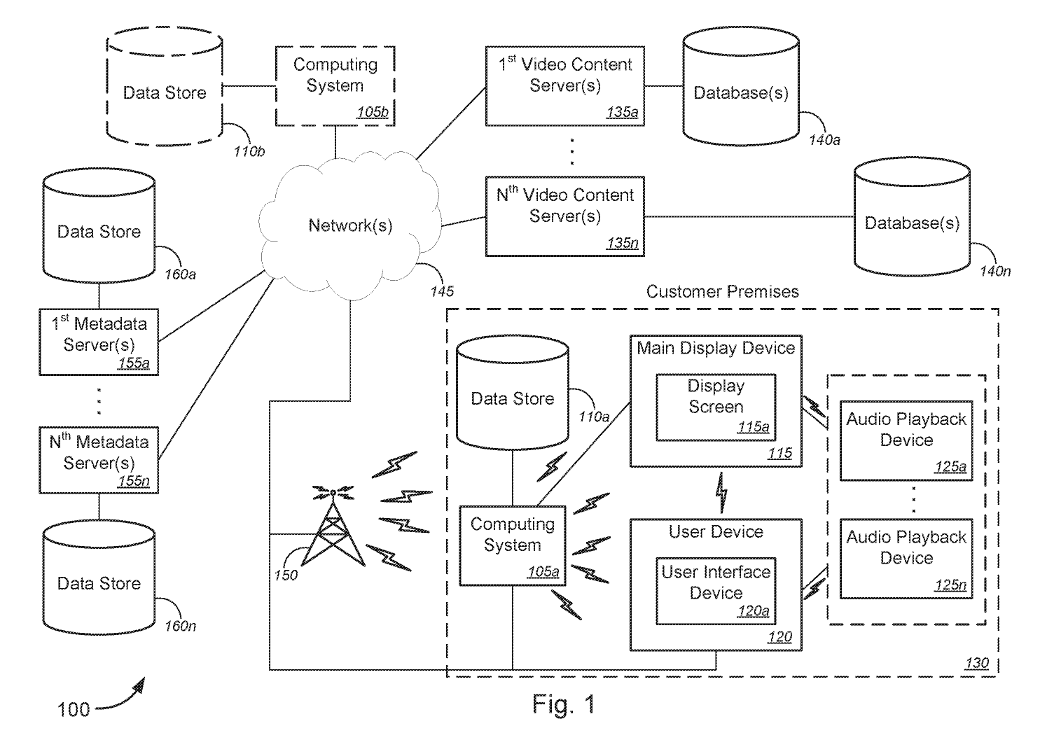

We now turn to the embodiments as illustrated by the drawings. FIGS. 1-6 illustrate some of the features of the method, system, and apparatus for implementing media content navigation and presentation, and, more particularly, to methods, systems, and apparatuses for implementing conflict resolution for electronic program guides, as referred to above. The methods, systems, and apparatuses illustrated by FIGS. 1-6 refer to examples of different embodiments that include various components and steps, which can be considered alternatives or which can be used in conjunction with one another in the various embodiments. The description of the illustrated methods, systems, and apparatuses shown in FIGS. 1-6 is provided for purposes of illustration and should not be considered to limit the scope of the different embodiments.

With reference to the figures, FIG. 1 is a schematic diagram illustrating a system 100 for implementing conflict resolution for electronic program guides, in accordance with various embodiments.

In the non-limiting embodiment of FIG. 1, system 100 might comprise a computing system 105a and a data store or database 110a that is local to the computing system 105a. In some cases, the data store 110a might be external, yet communicatively coupled, to the computing system 105a. In other cases, the data store 110a might be integrated within the computing system 105a. System 100, according to some embodiments, might further comprise one or more main display devices 115 (collectively, “main display devices 115” or “display devices 115,” or the like), which might each include a display screen 115a, and one or more user devices 120 (collectively, “user devices 120” or the like), which might each include a user interface device 120a (which in some cases might include, without limitation, a touchscreen display, a keypad, a keyboard, or other user interface devices, and/or the like), and/or the like. In some cases, system 100 might further, or optionally, comprise one or more audio playback devices 125a-125n (collectively, “audio playback devices 125” or “speakers 125,” or the like), and/or the like.

Each of the one or more main display devices 115 and/or the one or more user devices 120 might communicatively couple to the computing system 105a, and/or to each other, either via wireless connection and/or via wired connection. The one or more user devices 120 might each receive user input from a user (in various embodiments, by receiving touch input or other user input from the user via the user interface device 120a), and might each relay the user input to the computing system 105a, according to some embodiments. In some cases, the user devices 120 might include, without limitation, at least one of a dedicated remote control device (with touchscreen display and/or with button keypads, or the like) that is associated with the computing system 105a, a universal remote control device (with touchscreen display and/or with button keypads) that has been paired, synced, or synchronized with the computing system 105a, a tablet computer that has been paired, synced, or synchronized with the computing system 105a, a smart phone that has been paired, synced, or synchronized with the computing system 105a, or other portable device (with touchscreen display and/or with keypads or other user interface devices) that has been paired, synced, or synchronized with the computing system 105a, and/or the like. In some cases, the computing system 105a, the data store 110a, the one or more main display devices 115 (including the display screen(s) 115a and/or the audio playback device(s) 125, etc.), and the user device(s) 120 may be disposed within a customer premises 130, which might be one of a single family house, a multi-dwelling unit (“MDU”) within a multi-dwelling complex (including, but not limited to, an apartment building, an apartment complex, a condominium complex, a townhouse complex, a mixed-use building, etc.), a motel, an inn, a hotel, an office building or complex, a commercial building or complex, an industrial building or complex, and/or the like.

In some embodiments, the computing system 105a might comprise one of a processor on the main display device running a software application (“app”), a processor on the user device running an app, a media device, and/or the like. In some cases, the media device might include, but is not limited to, one of an electronic program guide (“EPG”), a metadata server, a set-top box (“STB”), a media player, a gaming console, a server computer, a desktop computer, or a laptop computer, and/or the like. The media player might include, without limitation, one of a digital versatile disc or digital video disc (“DVD”) player, a Blu-ray disc (“BD”) player, a digital video recording (“DVR”) device, a streaming video player, or a streaming game player, and/or the like, while the one or more main display devices 115 might include, but are not limited to, at least one of one or more monitors (e.g., computer monitor or laptop monitor, or the like), one or more television sets (e.g., smart television sets or other television sets, or the like), a projection system, and/or the like. In some cases, the user device 120 might include, without limitation, one of a laptop computer, a tablet computer, a smart phone, a mobile phone, a personal digital assistant, a remote control device, or a portable gaming device, and/or the like.

System 100 might further comprise one or more first video content sources or servers 135a through one or more N^{th} video content sources or servers 135n (collectively, “video content sources 135,” “video content servers 135,” or the like) and corresponding databases 140a-140n (collectively, “databases 140” or the like) that might communicatively couple to the computing system 105a via one or more networks 145 (and in some cases, via one or more telecommunications relay systems 150, which might include, without limitation, one or more wireless network interfaces (e.g., wireless modems, wireless access points, and the like), one or more towers, one or more satellites, and/or the like). The lightning bolt symbols are used to denote wireless communications between the one or more telecommunications relay systems 150 and the computing system 105a, between the one or more telecommunications relay systems 150 and each of at least one of the user devices 120, between the computing system 105a and each of at least one of the main display devices 115, between the computing system 105a and each of at least one of the user devices 120, between the main display device 115 and the user devices 120, between the computing system 105a and each of the one or more audio playback devices 125a-125n, between the main display device 115 and each of at least one of the one or more audio playback devices 125a-125n, between the user devices 120 and each of at least one of the one or more audio playback devices 125a-125n, and/or the like.

According to some embodiments, alternative or additional to the computing system 105a and corresponding data store 110a being disposed within customer premises 130, system 100 might comprise remote computing system 105b and corresponding data store(s) 110b that communicatively couple with the one or more main display devices 115 and/or with the one or more user devices 120 in the customer premises 130 via the one or more networks 145 (and in some cases, via the one or more telecommunications relay systems 150). According to some embodiments, remote computing system 105b might comprise at least one of a server computer over a network, a cloud-based computing system over a network, and/or the like.

In some embodiments, system 100 might further comprise one or more first metadata sources or servers 155a through one or more N^{th} metadata sources or servers 155n (collectively, “metadata sources 155,” “metadata servers 155,” or the like) and corresponding data stores 160a-160n (collectively, “data stores 160” or the like) that might communicatively couple to the computing system 105a via the one or more networks 145 (and in some cases, via one or more telecommunications relay systems 150). The metadata sources 155 and corresponding data stores 160 might provide the computing system 105a or 105b with access to metadata corresponding to video content that is available from the video content sources 135 and corresponding databases 140. In some cases, the plurality of video content sources 135 might include, but is not limited to, at least two of one or more video streaming sources, one or more video broadcast sources, one or more off the air (“OTA”) sources, or one or more third party video content sources, and/or the like.

In operation, the computing system 105a or 105b (collectively, “computing system 105,” or the like, which in some cases may be embodied by a set-top box (“STB”) or the like) might receive a plurality of first metadata each from a metadata source among a plurality of metadata sources, each of the first metadata corresponding to first video content among a plurality of video content. The computing system 105 might also compile the plurality of first metadata from the plurality of metadata sources. The computing system 105 might further determine whether at least one first metadata of the plurality of first metadata is inconsistent with other first metadata of the plurality of first metadata. Based on a determination that at least one first metadata of the plurality of first metadata is inconsistent with other first metadata of the plurality of first metadata, the computing system 105 might analyze the plurality of first metadata to determine which set of first metadata more accurately corresponds to the first video content, might modify one or more of the plurality of first metadata based on which set of first metadata is determined to more accurately correspond to the first video content, might generate an EPG that presents the first video content in a list, using first metadata consistent with the modified one or more of the plurality of first metadata, and might display the EPG on the display screen 115a of the display device 115.

According to some embodiments, the EPG might be a conventional EPG. Alternatively, the EPG might be a unified multi-source video programming and navigation guide (“UPG”) that is described in detail in the '770 application, which has already been incorporated herein by reference in its entirety for all purposes.

In some embodiments, determining whether at least one first metadata of the plurality of first metadata is inconsistent with other first metadata of the plurality of first metadata and analyzing the plurality of first metadata to determine which set of first metadata more accurately corresponds to the first video content might comprise using one of a voting scheme technique, a metadata provider ranking technique, a self-learning adaptive technique, an image recognition technique, an audio recognition technique, a video recognition technique, or a combination of these techniques, and/or the like.

Consistent with the voting scheme technique, determining whether at least one first metadata of the plurality of first metadata is inconsistent with other first metadata of the plurality of first metadata and analyzing the plurality of first metadata to determine which set of first metadata more accurately corresponds to the first video content might comprise identifying, with the computing system 105, which one or more portions of the plurality of first metadata are inconsistent with corresponding one or more portions of the plurality of first metadata and determining, with the computing system 105, whether the identified one or more portions of the plurality of first metadata represent a majority over the corresponding one or more portions of the plurality of first metadata. Based on a determination that the identified one or more portions of the plurality of first metadata represent a majority over the corresponding one or more portions of the plurality of first metadata, the computing system 105 might designate the identified one or more portions of the plurality of first metadata as more accurately corresponding to the first video content. On the other hand, based on a determination that the corresponding one or more portions of the plurality of first metadata represent a majority over the identified one or more portions of the plurality of first metadata, the computing system 105 might designate the corresponding one or more portions of the plurality of first metadata as more accurately corresponding to the first video content.

Consistent with the metadata provider ranking technique, each of the plurality of first metadata might comprise an accuracy counter value associated with corresponding one of the plurality of metadata sources, the accuracy counter value indicating a level of accuracy that each of the plurality of metadata sources has with respect to the first metadata. In such embodiments, determining whether at least one first metadata of the plurality of first metadata is inconsistent with other first metadata of the plurality of first metadata and analyzing the plurality of first metadata to determine which set of first metadata more accurately corresponds to the first video content might comprise identifying, with the computing system 105, a metadata source among the plurality of metadata sources that is associated with the highest accuracy counter value and designating, with the computing system 105, the first metadata among the plurality of first metadata corresponding to the identified metadata source as more accurately corresponding to the first video content. In some instances, the computing system 105 might increment the accuracy counter value of the designated first metadata corresponding to the identified metadata source as more accurately corresponding to the first video content. In other cases, the computing system 105 might decrement the accuracy counter value of first metadata corresponding to a metadata source providing first metadata deemed to be inconsistent with other first metadata of the plurality of first metadata.

Consistent with the self-learning adaptive technique, determining whether at least one first metadata of the plurality of first metadata is inconsistent with other first metadata of the plurality of first metadata and analyzing the plurality of first metadata to determine which set of first metadata more accurately corresponds to the first video content might comprise determining, with the computing system 105, accuracy of first metadata associated with at least one metadata source of the plurality of metadata sources over a predetermined period of time. According to some embodiments, the predetermined period of time might include, but is not limited to, a recent time period, a week, a day, an hour, half an hour, a quarter hour, ten minutes, five minutes, and/or the like.

Based on a determination that the first metadata associated with the at least one metadata source is accurate for at least a predetermined threshold percentage of instances over the predetermined period of time, the computing system 105 might increment the accuracy counter value of the first metadata associated with the at least one metadata source. On the other hand, based on a determination that the first metadata associated with the at least one metadata source is not accurate for at least the predetermined threshold percentage of instances over the predetermined period of time, the computing system 105 might decrement the accuracy counter value of the first metadata associated with the at least one metadata source.

According to some embodiments, determining whether at least one first metadata of the plurality of first metadata is inconsistent with other first metadata of the plurality of first metadata and analyzing the plurality of first metadata to determine which set of first metadata more accurately corresponds to the first video content might comprise analyzing, with the computing system 105, at least portions of the first video content using at least one of image recognition techniques, audio recognition techniques, or video recognition techniques to identify content information related to the first metadata and determining, with the computing system 105, whether the first metadata associated with at least one metadata source is consistent with the identified content information. Based on a determination that the first metadata associated with the at least one metadata source is consistent with the identified content information, the computing system 105 might designate the first metadata associated with the at least one metadata source as more accurately corresponding to the first video content. Based on a determination that the first metadata associated with the at least one metadata source is not consistent with the identified content information, the computing system 105 might designate the first metadata associated with the at least one metadata source as less accurately corresponding to the first video content.

Merely by way of example, in some embodiments, the identified content information might be based on at least one of logos or symbols associated with the first video content, music associated with the first video content, news personalities associated with the first video content, actors or actresses associated with the first video content, characters associated with the first video content, scenes associated with the first video content, phrases associated with the first video content, credits associated with the first video content, logos or symbols associated with a video content source associated with the first video content, music associated with the video content source associated with the first video content, news personalities associated with the video content source associated with the first video content, actors or actresses associated with the video content source associated with the first video content, characters associated with the video content source associated with the first video content, phrases associated with the video content source associated with the first video content, or credits associated with the video content source associated with the first video content, and/or the like.

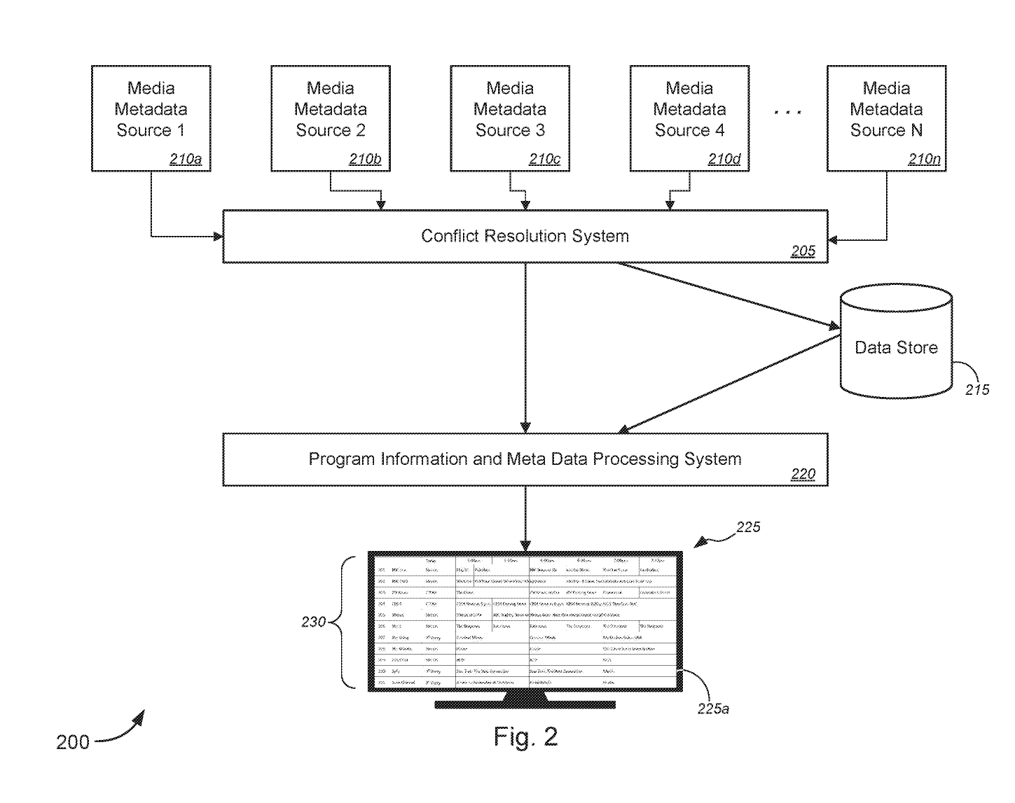

In the various embodiments, metadata for media content (e.g., video, audio, or other content, or the like) may be obtained from multiple sources, as depicted by the 1^{st} through N^{th} metadata servers 155a-155n of FIG. 1 or media metadata sources 1 through N 210a-210n of FIG. 2, or the like. Metadata can be obtained on a “push” basis (i.e., metadata providers push out new data whenever updated information is available, or the like) or on a “pull” basis (i.e., an ingest and/or conflict resolution mechanism or system requests new metadata whenever it is needed, or the like). In some embodiments, the system 100 may be independent of the push or pull method, and can work using either or both methods. System 100 is also applicable to a hybrid “push and pull” architecture, in which some metadata providers use a “push” method, while other providers use a “pull” method. In some cases, the hybrid “push and pull” architecture may be applicable to a single provider the uses a “push” method at certain times, while using a “pull” method at other times.

In addition, the techniques described herein are not limited to systems that obtain metadata information once for each piece of content. For example, more sophisticated systems can obtain metadata, either on a push or pull basis as described above, and can continue to structure, parse, and evaluate the metadata and potentially resolve any conflicts, and subsequently populate an EPG, all on a continual or continuous basis. Thus, the EPG's metadata can be updated on a dynamic basis, as an ongoing effort to provide up-to-date, accurate, and/or best-possible metadata to subscribers.

Metadata that has been obtained from a provider can potentially be processed or formatted as needed. Metadata can also be cached at the ingest stage and temporarily stored prior to the ingestion and conflict resolution process. Once metadata for a given content item has been obtained from multiple providers, it can be sorted according to criteria best suited for an operator's EPG structure. Typically, this can be a channel number or channel name, but any other sort criteria are equally or similarly valid.

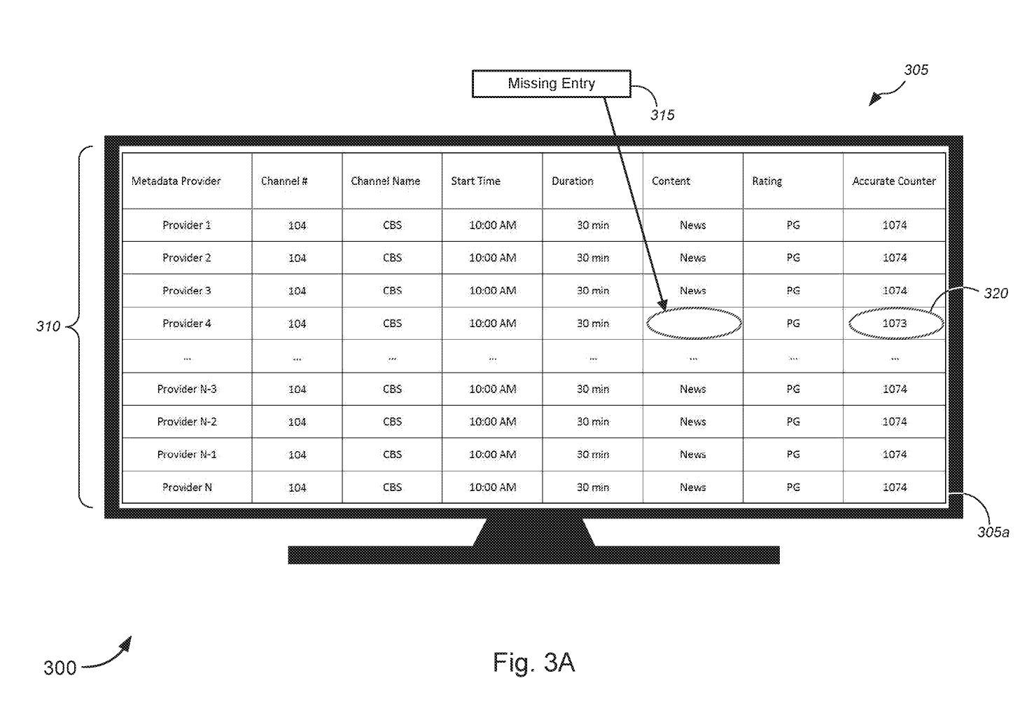

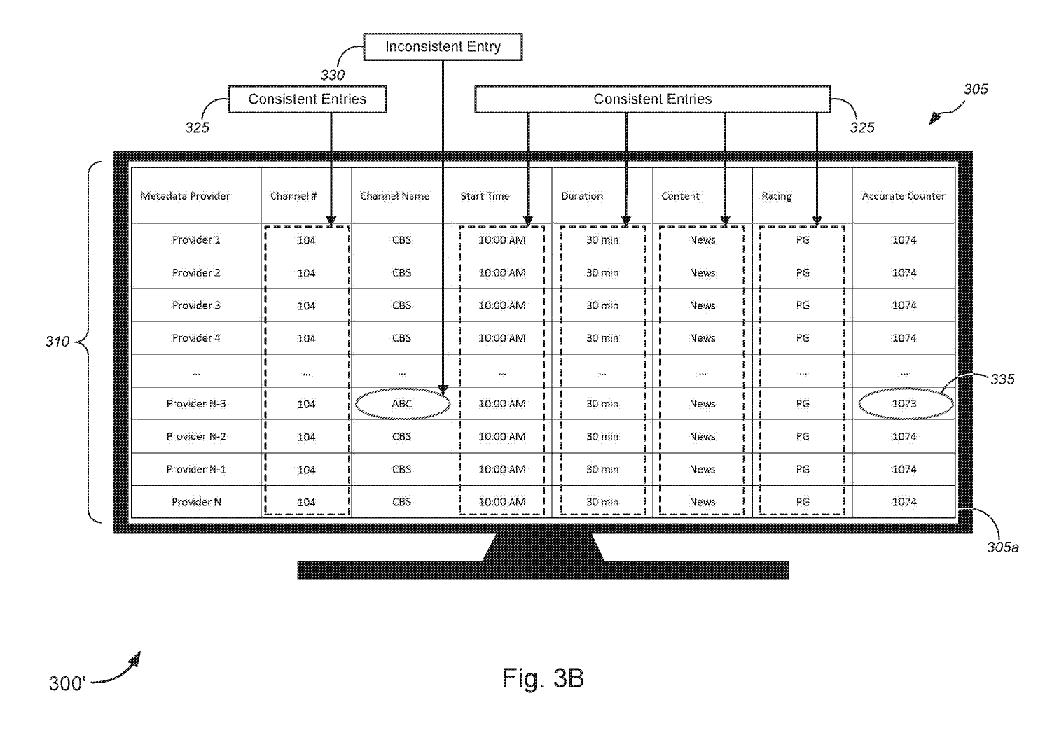

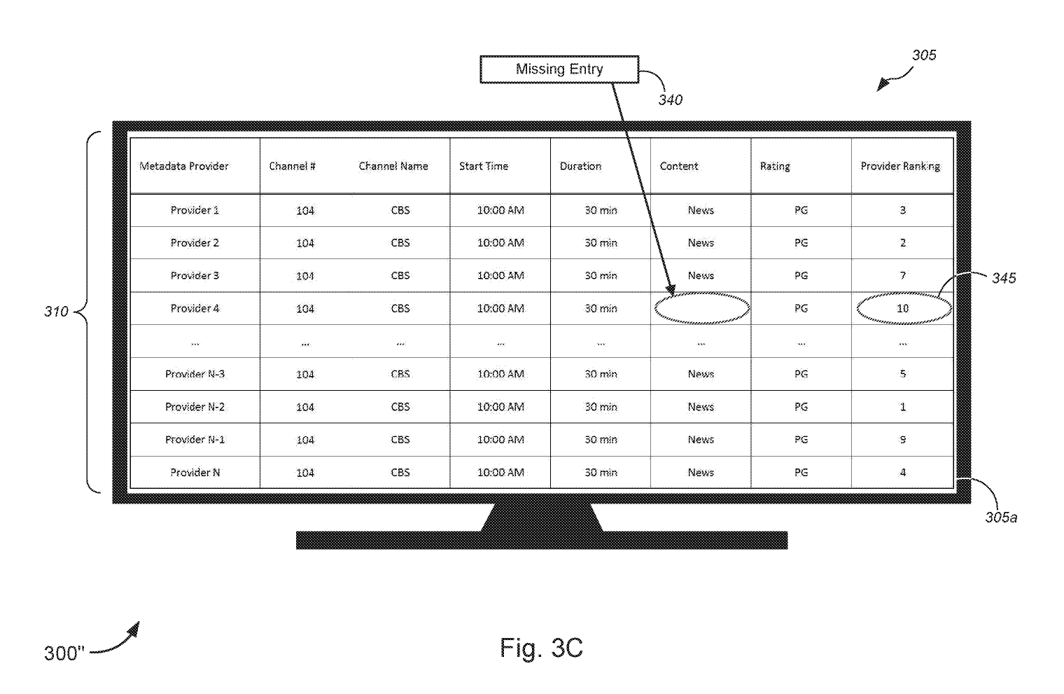

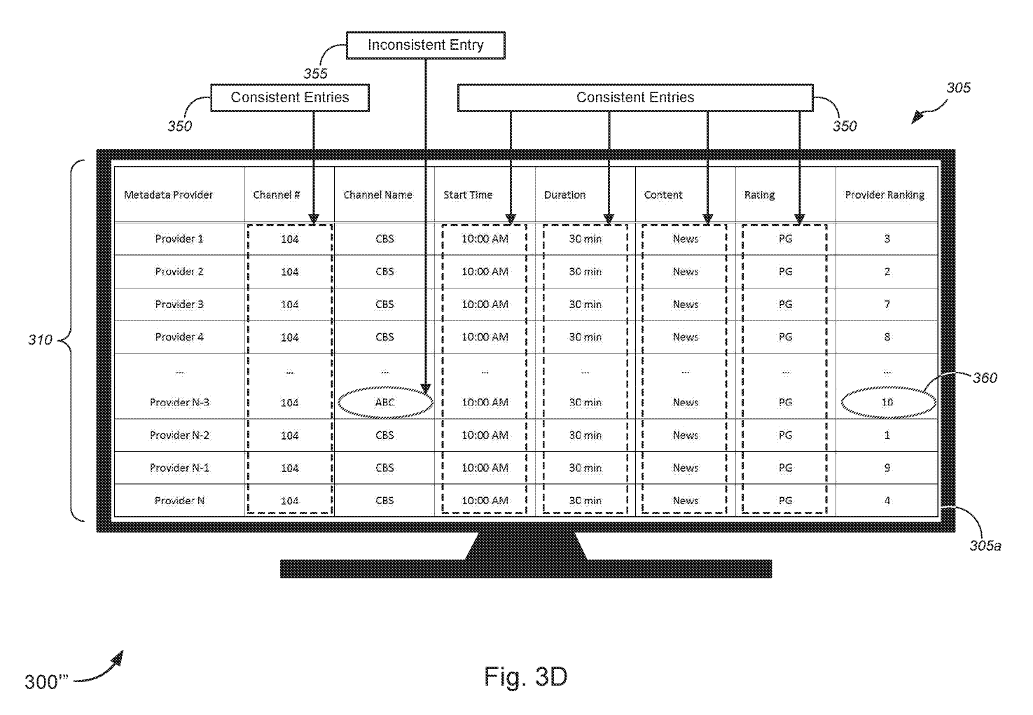

The metadata may be structured into an internal table and stored in memory as a file, or both. The conflict resolution mechanism or system may then parse the table to determine if a particular piece of content, channel, or metadata is missing any information or has one or more inconsistent entries (e.g., due to the metadata being sourced from multiple providers, or the like). FIGS. 3A and 3C illustrate examples of such a table with an entry missing the content type information (in this particular example, a news program). FIGS. 3B and 3D illustrate examples of such a table with an inconsistent entry (in this particular example, an inconsistent channel name). Here, the channel name and content type are merely examples of metadata that could potentially be missing, incorrect, or inconsistent across multiple metadata provider databases. The methods described herein are applicable to any missing or inconsistent metadata, including, but not limited to, at least one of advertisements, alternate_preview, alternate_title, backdrop, broadcast_date, can_fastforward, cast, category, channel_id, channel source_id, children, content_id, content subtype, content_type, cover_landscape, cover_portrait, date, description, device_type, directors, duration, dynamic_preview, eligibility, end_timestamp, end_validity, end_validity_timestamp, episode_name, episode number, filters, filters_id, general_item, genre, id, implies, logo, logo_url, new_contents, parental_control_level, pictures, playback_bitrate_id, playback_location, position, preview, prime_time_level, producers, program alternate_id, program_id, program source_id, provider, proxy_version, rating_id, recordable, requires, restricted age, revision, revision_type, season_id, season_number, series_id, short_description, short_summary, source_id, start_over, start_over_uri, start_timestamp, start_validity, start_validity_timestamp, startover_location, status, subcategory, subscriptions, subscriptions_id, subtitle, thumbnail, title, tracking_enabled, trailer_location, video_definition, year, and/or the like.

As mentioned above, some embodiments of the techniques for resolving conflicts or inconsistent information might include, without limitation, a voting scheme technique, a metadata provider ranking technique, a self-learning adaptive technique, an image recognition technique, an audio recognition technique, a video recognition technique, or a combination of these techniques, and/or the like.

Regarding the voting scheme technique, for each piece of conflicting or missing metadata, the conflict resolution mechanism or system might sort all of the respective entries and might select the entry submitted by the greatest number of metadata providers. These entries would have the highest confidence and are deemed to be correct, under the voting scheme technique. For example, if 8 of 10 metadata providers indicate that a particular media content is classified as “news” content, while the remaining 2 metadata providers either do not indicate the content as being “news” content or leaves this field blank, the conflict resolution mechanism or system would, under the voting scheme technique, determine that “news” content is the majority vote for type of content, and would accordingly modify or fill the corresponding field for the remaining 2 metadata providers to be consistent with the majority (i.e., to list “news” content in this example).

In the case of a tie, i.e., where the exact same number of metadata providers submit mutually conflicting data (resulting in the same number of votes; e.g., 5 of 10 metadata providers indicate that a particular media content is classified as “news” content, while the remaining 5 of 10 metadata providers indicate that the particular media content is classified as “talk show” content, or the like), the conflict resolution mechanism or system might rely on the metadata provider ranking technique and/or the self-learning adaptive technique (both of which are described below). If there is still a tie after resorting to secondary and tertiary resolution mechanisms, another method might be invoked as a further step for resolution or a value may be randomly chosen. According to some embodiments, a feedback mechanism may be able to determine the accuracy of the metadata selection and may provide valuable information for improving future metadata accuracy.

Regarding the metadata provider ranking technique, operators can rank or prioritize metadata providers based on any relevant criteria, including, but not limited to, the accuracy of information that is being provided. Such a ranking can be done based on subscriber feedback or via operational data available to the operator. If a feedback mechanism exists to determine correct metadata (potentially during or after a piece of content has been broadcast or otherwise made available to subscribers), the system may be self-adaptive and might compare the correct metadata with information that was submitted by each metadata provider. If the previously submitted metadata was correct, the system can increase a counter (e.g., an accuracy counter, as depicted in FIGS. 3A and 3B, or the like) to track the number of correct submissions by each metadata provider. For example, the accuracy counter can be incremented by “1” for every correct submission. Other values are also possible, thus enabling additional options for more refined confidence tracking mechanisms of metadata providers' data. In the self-learning scheme, the accuracy counter may be used to sort metadata providers in case of conflicting metadata. Metadata providers with the higher (or highest) accuracy counter values are preferred over ones with lower counts). Alternative to accuracy counter values, metadata provider ranking values can be used to rank metadata providers in terms of accuracy of metadata provided (as depicted, e.g., in FIGS. 3C and 3D, or the like). In some embodiments, operators or vendors can select a method where they first use a metadata provider ranking, then use an accuracy counter. Alternatively, the operators or vendors can use an accuracy counter as a first order decision criterion, followed by metadata provider ranking.

Regarding the self-learning scheme technique, a dynamic self-adaptive scheme can also use the accuracy counter to adjust the metadata provider ranking. For example, the accuracy counter can correspond directly to the metadata provider ranking, i.e., metadata providers with the highest accuracy counter value also have the highest confidence ranking. A more sophisticated scheme can utilize the accuracy counter over variable periods of time, thus adjusting or changing the metadata provider more slowly. In other words, it may be more forgiving in the sense that a short glitch (missing or incorrect data) does not necessarily alter the ranking of a source that has historically provided very accurate metadata right away.

Another mechanism or system can consider the accuracy rating of a more recent time period, giving more recent metadata accuracy a higher weight than older accuracy counts. This may give a metadata provider an opportunity to improve their ranking with operators by continuing to improve the quality and accuracy of their own metadata. In a sense, older inaccuracies may carry less weight and would over time be forgiven.

According to some embodiments, the voting scheme described above can also be used as a feedback mechanism or system to rank metadata providers in terms of confidence in the data set they provide. If a piece of metadata is deemed to be correct based on the voting scheme, its associated metadata provider may be tagged accordingly and/or a counter representing the number of correct metadata entries for each provider is increased (i.e., accuracy counter). Another, alternative approach might use human input to spot-check metadata by comparing it with the ultimately broadcast content.

In some embodiments, a sophisticated feedback mechanism might look at the received video stream and use image recognition technology to determine the nature of the content and thus derive knowledge about metadata associated with this content. For example, the image recognition system can look at information such as station logos and credits to determine content information. An even more capable system can include audio and video recognition, able to determine the type of program and associated metadata by recognizing characters, scenes, key props as well as voices and music. It can then correlate this information with the metadata previously received and determine metadata accuracy.

The various embodiments provide customers with confidence that the information in an EPG is correct and up-to-date. Service providers implementing such embodiments are provided the ability to provide services featuring EPGs (e.g., streaming video and other media) with higher accuracy and up-to-date information.

FIG. 2 is a schematic diagram illustrating another system 200 for implementing conflict resolution for electronic program guides, in accordance with various embodiments.

In the non-limiting embodiment of FIG. 2, system 200 might comprise conflict resolution system 205, one or more media metadata sources 1, 2, 3, 4, through N 210a, 210b, 210c, 210d, through 210n (collectively, “media metadata sources 210,” “video metadata sources 210,” “metadata sources 210,” or the like), data store 215, program information and metadata processing system 220, display device 225, and/or the like. In some instances, the one or more media metadata sources 210 might include, without limitation, one or more video streaming metadata sources, one or more video broadcast metadata sources, one or more off the air (“OTA”) metadata sources, one or more third party video content metadata sources, or one or more partner provider metadata sources, and/or the like.

The conflict resolution system 205 might receive a plurality of first metadata each from a metadata source 210 among a plurality of metadata sources 210, each of the first metadata corresponding to first video content among a plurality of video content. The conflict resolution system 205 might also compile the plurality of first metadata from the plurality of metadata sources. The conflict resolution system 205 might further determine whether at least one first metadata of the plurality of first metadata is inconsistent with other first metadata of the plurality of first metadata. Based on a determination that at least one first metadata of the plurality of first metadata is inconsistent with other first metadata of the plurality of first metadata, the conflict resolution system 205 might analyze the plurality of first metadata to determine which set of first metadata more accurately corresponds to the first video content, and might modify one or more of the plurality of first metadata based on which set of first metadata is determined to more accurately correspond to the first video content. In some cases, the conflict resolution system 205 might store the first metadata (whether modified or not) in data store 215. Program information and metadata processing system 205 might generate an EPG that presents the first video content in a list, using first metadata consistent with the modified one or more of the plurality of first metadata, and might display the EPG 230 on the display screen 225a of the display device 225. According to some embodiments, the EPG 230 might be a conventional EPG. Alternatively, the EPG 230 might be a unified multi-source video programming and navigation guide (“UPG”) that is described in detail in the '770 application, which has already been incorporated herein by reference in its entirety for all purposes.

According to some embodiments, determining whether at least one first metadata of the plurality of first metadata is inconsistent with other first metadata of the plurality of first metadata and analyzing the plurality of first metadata to determine which set of first metadata more accurately corresponds to the first video content might comprise using one of a voting scheme technique, a metadata provider ranking technique, a self-learning adaptive technique, an image recognition technique, an audio recognition technique, a video recognition technique, or a combination of these techniques, and/or the like.

Consistent with the voting scheme technique, determining whether at least one first metadata of the plurality of first metadata is inconsistent with other first metadata of the plurality of first metadata and analyzing the plurality of first metadata to determine which set of first metadata more accurately corresponds to the first video content might comprise identifying, with the conflict resolution system 205, which one or more portions of the plurality of first metadata are inconsistent with corresponding one or more portions of the plurality of first metadata and determining, with the conflict resolution system 205, whether the identified one or more portions of the plurality of first metadata represent a majority over the corresponding one or more portions of the plurality of first metadata. Based on a determination that the identified one or more portions of the plurality of first metadata represent a majority over the corresponding one or more portions of the plurality of first metadata, the conflict resolution system 205 might designate the identified one or more portions of the plurality of first metadata as more accurately corresponding to the first video content. On the other hand, based on a determination that the corresponding one or more portions of the plurality of first metadata represent a majority over the identified one or more portions of the plurality of first metadata, the conflict resolution system 205 might designate the corresponding one or more portions of the plurality of first metadata as more accurately corresponding to the first video content.

Consistent with the metadata provider ranking technique, each of the plurality of first metadata might comprise an accuracy counter value associated with corresponding one of the plurality of metadata sources, the accuracy counter value indicating a level of accuracy that each of the plurality of metadata sources has with respect to the first metadata. In such embodiments, determining whether at least one first metadata of the plurality of first metadata is inconsistent with other first metadata of the plurality of first metadata and analyzing the plurality of first metadata to determine which set of first metadata more accurately corresponds to the first video content might comprise identifying, with the conflict resolution system 205, a metadata source among the plurality of metadata sources that is associated with the highest accuracy counter value and designating, with the conflict resolution system 205, the first metadata among the plurality of first metadata corresponding to the identified metadata source as more accurately corresponding to the first video content. In some instances, the conflict resolution system 205 might increment the accuracy counter value of the designated first metadata corresponding to the identified metadata source as more accurately corresponding to the first video content. In other cases, the conflict resolution system 205 might decrement the accuracy counter value of first metadata corresponding to a metadata source providing first metadata deemed to be inconsistent with other first metadata of the plurality of first metadata.

Consistent with the self-learning adaptive technique, determining whether at least one first metadata of the plurality of first metadata is inconsistent with other first metadata of the plurality of first metadata and analyzing the plurality of first metadata to determine which set of first metadata more accurately corresponds to the first video content might comprise determining, with the conflict resolution system 205, accuracy of first metadata associated with at least one metadata source of the plurality of metadata sources over a predetermined period of time. According to some embodiments, the predetermined period of time might include, but is not limited to, a recent time period, a week, a day, an hour, half an hour, a quarter hour, ten minutes, five minutes, and/or the like.

Based on a determination that the first metadata associated with the at least one metadata source is accurate for at least a predetermined threshold percentage of instances over the predetermined period of time, the conflict resolution system 205 might increment the accuracy counter value of the first metadata associated with the at least one metadata source. On the other hand, based on a determination that the first metadata associated with the at least one metadata source is not accurate for at least the predetermined threshold percentage of instances over the predetermined period of time, the conflict resolution system 205 might decrement the accuracy counter value of the first metadata associated with the at least one metadata source.

According to some embodiments, determining whether at least one first metadata of the plurality of first metadata is inconsistent with other first metadata of the plurality of first metadata and analyzing the plurality of first metadata to determine which set of first metadata more accurately corresponds to the first video content might comprise analyzing, with the conflict resolution system 205, at least portions of the first video content using at least one of image recognition techniques, audio recognition techniques, or video recognition techniques to identify content information related to the first metadata and determining, with the conflict resolution system 205, whether the first metadata associated with at least one metadata source is consistent with the identified content information. Based on a determination that the first metadata associated with the at least one metadata source is consistent with the identified content information, the conflict resolution system 205 might designate the first metadata associated with the at least one metadata source as more accurately corresponding to the first video content. Based on a determination that the first metadata associated with the at least one metadata source is not consistent with the identified content information, the conflict resolution system 205 might designate the first metadata associated with the at least one metadata source as less accurately corresponding to the first video content.

Merely by way of example, in some embodiments, the identified content information might be based on at least one of logos or symbols associated with the first video content, music associated with the first video content, news personalities associated with the first video content, actors or actresses associated with the first video content, characters associated with the first video content, scenes associated with the first video content, phrases associated with the first video content, credits associated with the first video content, logos or symbols associated with a video content source associated with the first video content, music associated with the video content source associated with the first video content, news personalities associated with the video content source associated with the first video content, actors or actresses associated with the video content source associated with the first video content, characters associated with the video content source associated with the first video content, phrases associated with the video content source associated with the first video content, or credits associated with the video content source associated with the first video content, and/or the like.

Programming information can be displayed according to any desired criteria, including, but not limited to, channel numbers, station names, genre, favorites, or a combination of these criteria, and/or the like. According to some embodiments, users might be able to navigate the EPG 230 in both x and y directions. The x-axis might be used to move forward or backward in time, while the y-axis might be used to move among channels or other content sources. Users can move among channel or other input sources in a seamless way, disregarding the nature of the content source (e.g., network stream, OTA, or the like), and/or the like. In some embodiments, OTA devices can contain more than one HDTV tuner or the like. In some cases, very compact devices with as many as four HDTV OTA tuners are readily available. There is no principal reason why the number of tuners cannot be significantly expanded in the future.

According to some embodiments, available content might vary, dependent on the user's location (or location of the customer premises), due to content blackout restrictions, locally available programming and content plan chosen by the subscriber. The program information and metadata processing system 205 can take advantage of location information, if available. For example, STBs could be shipped preconfigured with the required location information to properly handle blackout restrictions and local programming. This data could also be derived based on other operator-provided information or information potentially available to the STB (e.g., subscriber phone number or the like). Alternatively, users can enter their address or zip code information or other customer information identifying their location. Advanced systems can also use methods of geolocation such as global positioning system (“GPS”) or comparable system to obtain location information, or the like. The software and/or hardware implementing the system described herein can reside on either the main STB or on the OTA receiver. Alternatively, parts of this unified EPG or UPG, or navigation system could be residing on both the OTA receiver as well as the main STB, and the like.

In addition to linear live content, the program guide can include locally stored on-demand content or remotely hosted on-demand content, or both. The EPG data can either be requested from the STB or program information and meta data processing system 220 (in a “pull” data distribution model) or offered from the external metadata sources (in a “push” data distribution model), or via a hybrid pull-push data distribution model. The updates and/or refreshes can be triggered based on a number of different events. The trigger might include, without limitation, one of power-up of the computing system, boot-up of the computing system, wake-up of the computing system, periodic update timer, user request operator instruction, or some other event internal or external to the STB, and/or the like.

The conflict resolution system 205 and the program information and metadata processing system 220, the display device 225, the one or more metadata sources 210a-210n of system 200 in FIG. 2 might otherwise be similar, if not identical, to the computing system 105, the display device 115, the one or more metadata sources 155a-155n, respectively, of system 100 in FIG. 1, and the descriptions of these components of system 100 are applicable to the corresponding components of system 200.

FIGS. 3A-3D (collectively, “Fig. 3”) are schematic diagrams illustrating various embodiments 300, 300′, 300″, and 300′″ of user interfaces and display screens depicting electronic program guides having conflicts or other errors to be corrected when implementing conflict resolution for electronic program guides.

In the non-limiting embodiment 300 of FIG. 3A, display device 305 might display, on display screen 305a, an EPG or UPG 310. In FIG. 3A, EPG 310 might list in a grid with one or more of metadata provider, channel number, channel name, start time, duration, content, rating, accuracy counter, and/or the like along one axis, while metadata entries from a plurality of metadata provider for a particular video content. For example, for CBS News on Channel 104 starting at 10:00 a.m., running for 30 minutes, and having a PG rating, a plurality of sets of metadata providing information including, but not limited to, metadata provider, channel number, channel name, start time, duration, content, rating, accuracy counter, and/or the like. In the set of metadata from metadata provider 4, for example, the content field might have a missing entry 315 (in this case, missing the content, “News”), as in the corresponding content field of each of the other metadata providers 1-3, (N-3) through N, or the like. In some cases, each metadata provider might have an associated accuracy counter field. For instance, the accuracy counter 320 might have a value of, e.g., 1073 for the metadata provider 4 having the missing entry 315, while the other metadata providers might have accuracy counter values of 1074, or the like.

Turning to FIG. 3B, in the non-limiting embodiment 300′, display device 305 might display, on display screen 305a, an EPG or UPG 310. In FIG. 3B, EPG 310 might list in a grid with one or more of metadata provider, channel number, channel name, start time, duration, content, rating, accuracy counter, and/or the like along one axis, while metadata entries from a plurality of metadata provider for a particular video content. For example, for CBS News on Channel 104 starting at 10:00 a.m., running for 30 minutes, and having a PG rating, a plurality of sets of metadata providing information including, but not limited to, metadata provider, channel number, channel name, start time, duration, content, rating, accuracy counter, and/or the like.

In some embodiments, embodiment 300′ might comprise a plurality of consistent entries 325 and at least one inconsistent entry 330. In this non-limiting example, the at least one inconsistent entry 330 might be in the channel name, e.g., “ABC” compared with the other channel names, e.g., “CBS.” In some cases, each metadata provider might have an associated accuracy counter field. For instance, the accuracy counter 335 might have a value of, e.g., 1073 for the metadata provider N-3 having the inconsistent entry 330, while the other metadata providers might have accuracy counter values of 1074, or the like.

With reference to FIG. 3C, in the non-limiting embodiment 300″, display device 305 might display, on display screen 305a, an EPG or UPG 310. In FIG. 3C, EPG 310 might list in a grid with one or more of metadata provider, channel number, channel name, start time, duration, content, rating, provider ranking, and/or the like along one axis, while metadata entries from a plurality of metadata provider for a particular video content. For example, for CBS News on Channel 104 starting at 10:00 a.m., running for 30 minutes, and having a PG rating, a plurality of sets of metadata providing information including, but not limited to, metadata provider, channel number, channel name, start time, duration, content, rating, provider ranking, and/or the like. In the set of metadata from metadata provider 4, for example, the content field might have a missing entry 340 (in this case, missing the content, “News”), as in the corresponding content field of each of the other metadata providers 1-3, (N-3) through N, or the like. In some cases, each metadata provider might have an associated provider ranking field. For instance, the provider ranking field 345 might have a value of 10 for the metadata provider 4 having the missing entry 340, while the other metadata providers might have provider ranking values better than 10 (e.g., 1 through 9, or the like). In some cases, provider ranking might be configured such that the higher the value, the greater the trustworthiness (in terms of accuracy of metadata) the metadata provider; in such cases, the provider 4having the missing entry 340 might have a provider ranking of 1, or the like (not shown).

Turning to FIG. 3D, in the non-limiting embodiment 300′″, display device 305 might display, on display screen 305a, an EPG or UPG 310. In FIG. 3D, EPG 310 might list in a grid with one or more of metadata provider, channel number, channel name, start time, duration, content, rating, provider ranking, and/or the like along one axis, while metadata entries from a plurality of metadata provider for a particular video content. For example, for CBS News on Channel 104 starting at 10:00 a.m., running for 30 minutes, and having a PG rating, a plurality of sets of metadata providing information including, but not limited to, metadata provider, channel number, channel name, start time, duration, content, rating, provider ranking, and/or the like.

In some embodiments, embodiment 300′″ might comprise a plurality of consistent entries 350 and at least one inconsistent entry 355. In this non-limiting example, the at least one inconsistent entry 355 might be in the channel name, e.g., “ABC” compared with the other channel names, e.g., “CBS.” In some cases, each metadata provider might have an associated provider ranking field. For instance, the provider ranking 360 might have a value of 10 for the metadata provider N-3 having the inconsistent entry 355, while the other metadata providers might have provider ranking values better than 10 (e.g., 1 through 9, or the like). In some cases, provider ranking might be configured such that the higher the value, the greater the trustworthiness (in terms of accuracy of metadata) the metadata provider; in such cases, the provider 4 having the missing entry 340 might have a provider ranking of 1, or the like (not shown).

Although specific metadata fields are depicted in the embodiments of FIGS. 3A-3D, the various embodiments are not so limited, and any combination of metadata may be listed in the EPG 310, and may be analyzed for consistency, inconsistency, accuracy, and/or the like. Examples of other metadata are provided above with respect to FIG. 1.

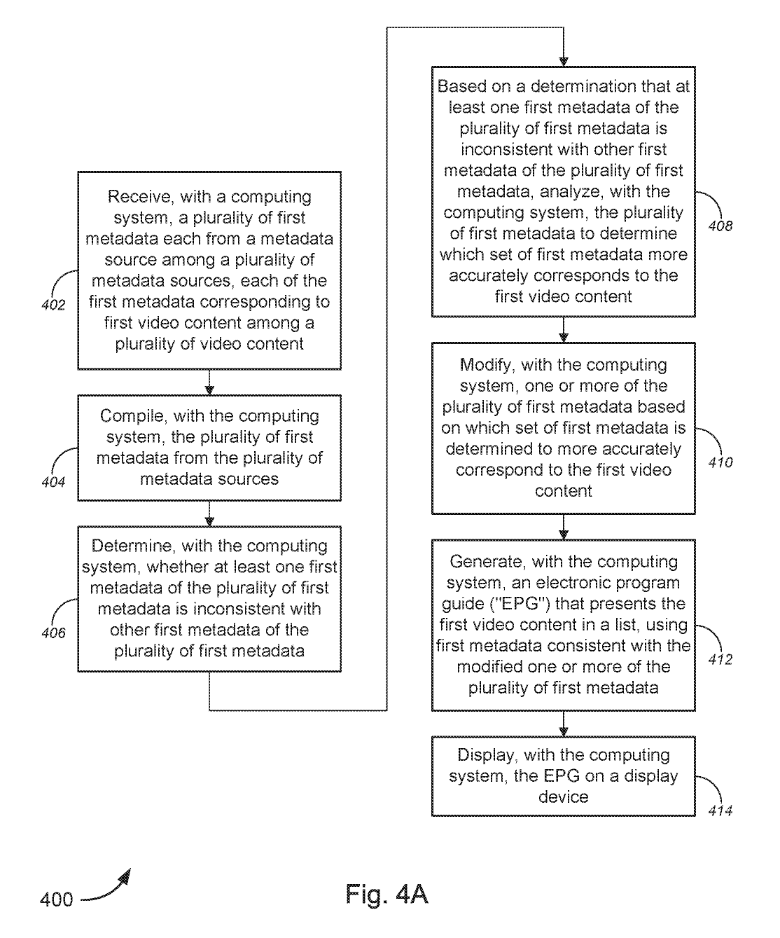

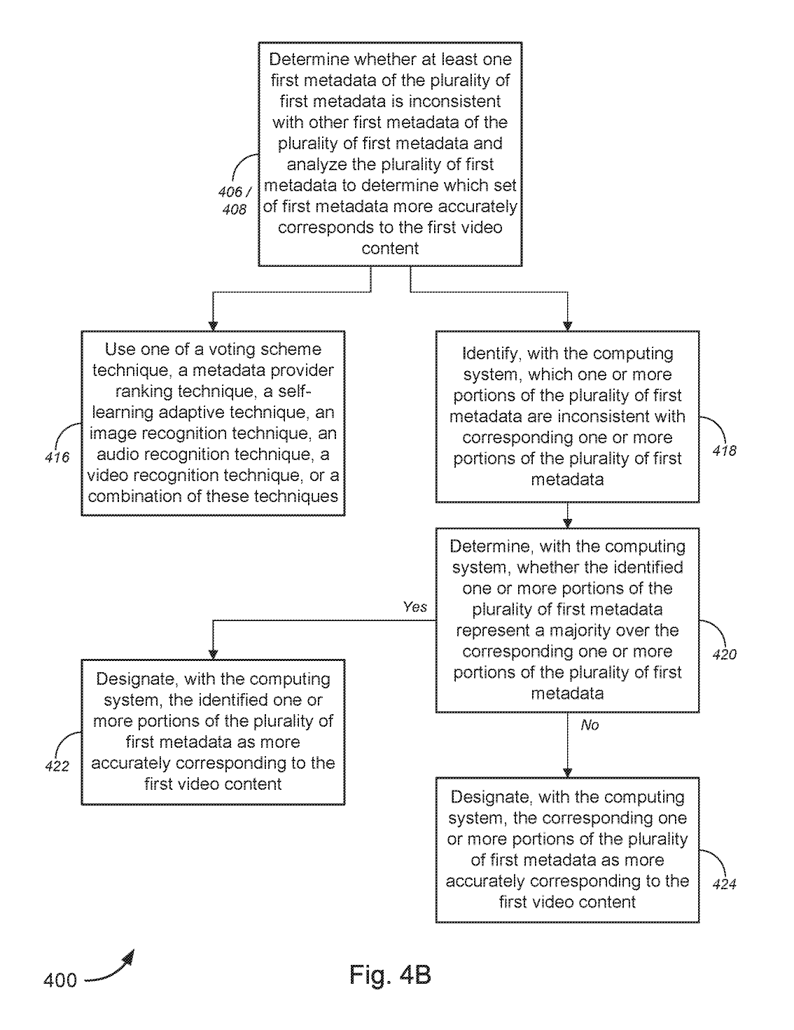

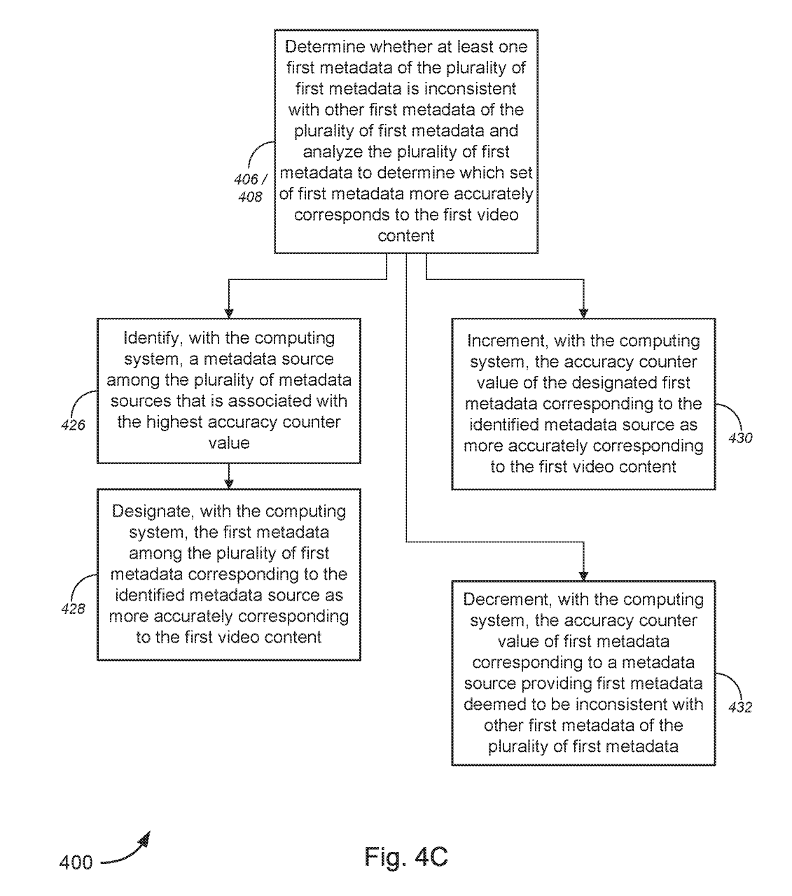

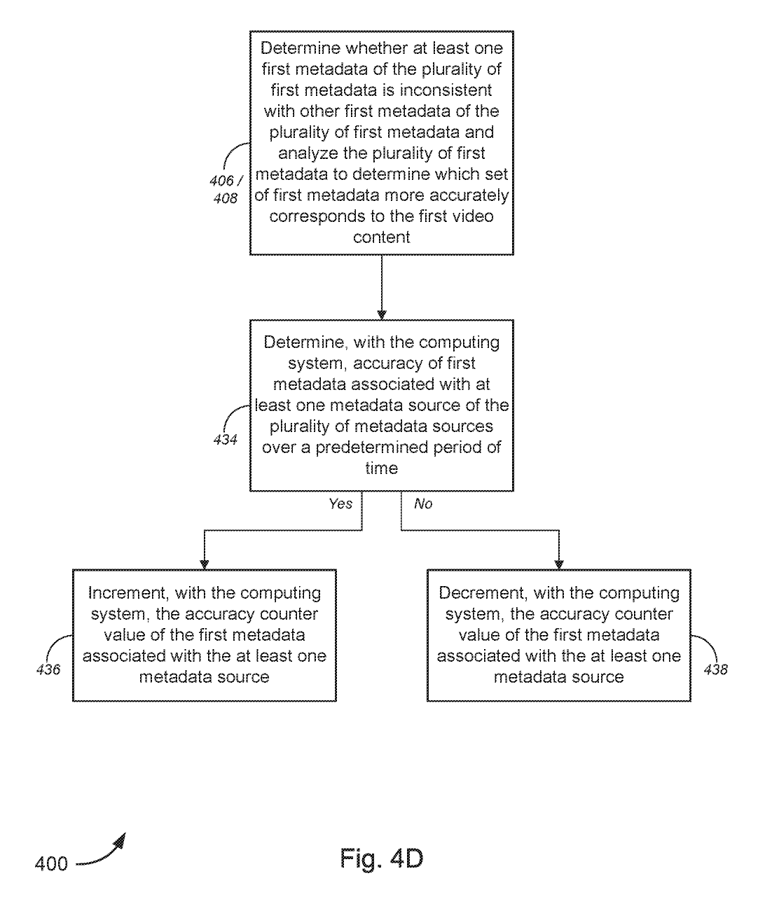

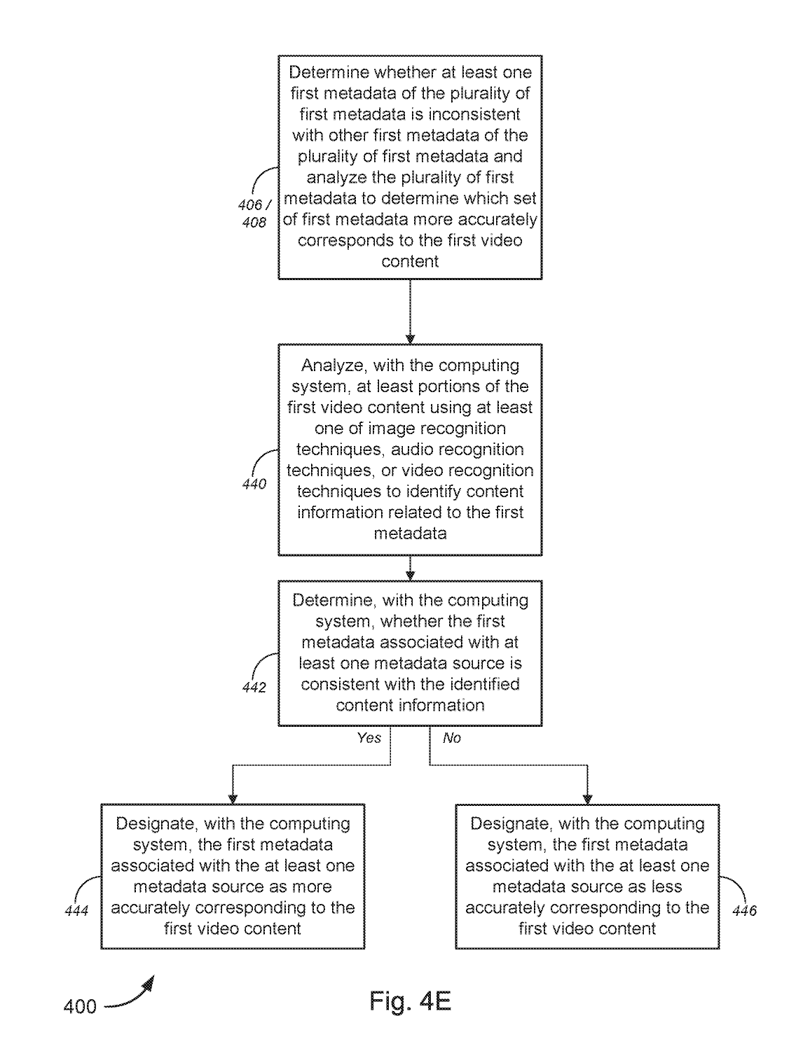

FIGS. 4A-4E (collectively, “FIG. 4”) are flow diagrams illustrating a method 400 for implementing conflict resolution for electronic program guides, in accordance with various embodiments.

While the techniques and procedures are depicted and/or described in a certain order for purposes of illustration, it should be appreciated that certain procedures may be reordered and/or omitted within the scope of various embodiments. Moreover, while the method 400 illustrated by FIG. 4 can be implemented by or with (and, in some cases, are described below with respect to) the systems 100, 200, 300, 300′, 300″, and 300′″ of FIGS. 1, 2, 3A, 3B, 3C, and 3D, respectively (or components thereof), such methods may also be implemented using any suitable hardware (or software) implementation. Similarly, while each of the systems 100, 200, 300, 300′, 300″, and 300′″ of FIGS. 1, 2, 3A, 3B, 3C, and 3D, respectively (or components thereof), can operate according to the method 400 illustrated by FIG. 4 (e.g., by executing instructions embodied on a computer readable medium), the systems 100, 200, 300, 300′, 300″, and 300′″ of FIGS. 1, 2, 3A, 3B, 3C, and 3D can each also operate according to other modes of operation and/or perform other suitable procedures.

In the non-limiting embodiment of FIG. 4A, method 400 might comprise receiving, with a computing system, a plurality of first metadata each from a metadata source among a plurality of metadata sources, each of the first metadata corresponding to first video content among a plurality of video content (block 402); compiling, with the computing system, the plurality of first metadata from the plurality of metadata sources (block 404); and determining, with the computing system, whether at least one first metadata of the plurality of first metadata is inconsistent with other first metadata of the plurality of first metadata (block 406). In some embodiments, the computing system might include, without limitation, one of an electronic program guide (“EPG”) system, a metadata server, a set-top box (“STB”), a digital video recording (“DVR”) device, a processor of the display device running a software application (“app”), a processor of a user device running an app, a server computer over a network, a cloud-based computing system over a network, a media player, or a gaming console, and/or the like.

Based on a determination that at least one first metadata of the plurality of first metadata is inconsistent with other first metadata of the plurality of first metadata, method 400, at block 408, might comprise analyzing, with the computing system, the plurality of first metadata to determine which set of first metadata more accurately corresponds to the first video content. At block 410, method 400 might comprise modifying, with the computing system, one or more of the plurality of first metadata based on which set of first metadata is determined to more accurately correspond to the first video content. Method 400 might further comprise generating, with the computing system, an EPG (or a unified multi-source video programming and navigation guide (“UPG”) that is described in detail in the '770 application, which has already been incorporated herein by reference in its entirety for all purposes) that presents the first video content in a list, using first metadata consistent with the modified one or more of the plurality of first metadata (block 412). Method 400 might further comprise, at block 414, displaying, with the computing system, the EPG on a display device. According to some embodiments, the display device might include, but is not limited to, one of a television set, a smart television, a computer monitor, a laptop monitor, or a projection system, and/or the like.

In some embodiments, the first video content might be available from a plurality of video content sources, each source including, without limitation, one of a video streaming source, a video broadcast source, an off the air (“OTA”) source, or a third party video content source, and/or the like. In some cases, each of the plurality of first metadata might be received by the computing system in response to one of a pull data distribution instruction (in which the computing system might ingest or request new metadata whenever it is needed, or the like), a push data distribution instruction (in which the metadata providers might push out, send out, or broadcast new metadata whenever updated information is available, or the like), or a hybrid push-pull data distribution instruction (in which metadata providers might, at times, push out, send out, or broadcast new metadata whenever updated information is available, or the like, while, at other times, the computing system might ingest or request new metadata whenever it is needed, or the like).

With reference to FIGS. 4B-4E, various embodiments are provided for implementation of the determination and analysis operations of blocks 406 and 408. For example, turning to FIG. 4B, determining whether at least one first metadata of the plurality of first metadata is inconsistent with other first metadata of the plurality of first metadata and analyzing the plurality of first metadata to determine which set of first metadata more accurately corresponds to the first video content (at blocks 406 and 408) might comprise using one of a voting scheme technique, a metadata provider ranking technique, a self-learning adaptive technique, an image recognition technique, an audio recognition technique, a video recognition technique, or a combination of these techniques, and/or the like (block 416). Consistent with the voting scheme technique, determining whether at least one first metadata of the plurality of first metadata is inconsistent with other first metadata of the plurality of first metadata and analyzing the plurality of first metadata to determine which set of first metadata more accurately corresponds to the first video content (at blocks 406 and 408) might comprise identifying, with the computing system, which one or more portions of the plurality of first metadata are inconsistent with corresponding one or more portions of the plurality of first metadata (block 418) and determining, with the computing system, whether the identified one or more portions of the plurality of first metadata represent a majority over the corresponding one or more portions of the plurality of first metadata (block 420). Based on a determination that the identified one or more portions of the plurality of first metadata represent a majority over the corresponding one or more portions of the plurality of first metadata, method 400 might comprise designating, with the computing system, the identified one or more portions of the plurality of first metadata as more accurately corresponding to the first video content (block 422). On the other hand, based on a determination that the corresponding one or more portions of the plurality of first metadata represent a majority over the identified one or more portions of the plurality of first metadata, method 400 might comprise designating, with the computing system, the corresponding one or more portions of the plurality of first metadata as more accurately corresponding to the first video content (block 424).

Referring to FIG. 4C, consistent with the metadata provider ranking technique, each of the plurality of first metadata might comprise an accuracy counter value associated with corresponding one of the plurality of metadata sources, the accuracy counter value indicating a level of accuracy that each of the plurality of metadata sources has with respect to the first metadata. In such embodiments, determining whether at least one first metadata of the plurality of first metadata is inconsistent with other first metadata of the plurality of first metadata and analyzing the plurality of first metadata to determine which set of first metadata more accurately corresponds to the first video content (at blocks 406 and 408) might comprise identifying, with the computing system, a metadata source among the plurality of metadata sources that is associated with the highest accuracy counter value (block 426) and designating, with the computing system, the first metadata among the plurality of first metadata corresponding to the identified metadata source as more accurately corresponding to the first video content (block 428). In some instances, method 400 might comprise incrementing, with the computing system, the accuracy counter value of the designated first metadata corresponding to the identified metadata source as more accurately corresponding to the first video content (block 430). In other cases, method 400 might comprise decrementing, with the computing system, the accuracy counter value of first metadata corresponding to a metadata source providing first metadata deemed to be inconsistent with other first metadata of the plurality of first metadata (block 432).

Turning to FIG. 4D, consistent with the self-learning adaptive technique, determining whether at least one first metadata of the plurality of first metadata is inconsistent with other first metadata of the plurality of first metadata and analyzing the plurality of first metadata to determine which set of first metadata more accurately corresponds to the first video content (at blocks 406 and 408) might comprise determining, with the computing system, accuracy of first metadata associated with at least one metadata source of the plurality of metadata sources over a predetermined period of time (block 434). According to some embodiments, the predetermined period of time might include, but is not limited to, a recent time period, a week, a day, an hour, half an hour, a quarter hour, ten minutes, five minutes, and/or the like.

Based on a determination that the first metadata associated with the at least one metadata source is accurate for at least a predetermined threshold percentage of instances over the predetermined period of time, method 400 might comprise incrementing, with the computing system, the accuracy counter value of the first metadata associated with the at least one metadata source (block 436). On the other hand, based on a determination that the first metadata associated with the at least one metadata source is not accurate for at least the predetermined threshold percentage of instances over the predetermined period of time, method 400 might comprise decrementing, with the computing system, the accuracy counter value of the first metadata associated with the at least one metadata source (block 438).

With reference to FIG. 4E, determining whether at least one first metadata of the plurality of first metadata is inconsistent with other first metadata of the plurality of first metadata and analyzing the plurality of first metadata to determine which set of first metadata more accurately corresponds to the first video content (at blocks 406 and 408) might comprise analyzing, with the computing system, at least portions of the first video content using at least one of image recognition techniques, audio recognition techniques, or video recognition techniques to identify content information related to the first metadata (block 440) and determining, with the computing system, whether the first metadata associated with at least one metadata source is consistent with the identified content information (block 442). Based on a determination that the first metadata associated with the at least one metadata source is consistent with the identified content information, method 400 might comprise designating, with the computing system, the first metadata associated with the at least one metadata source as more accurately corresponding to the first video content (block 444). Based on a determination that the first metadata associated with the at least one metadata source is not consistent with the identified content information, method 400 might comprise designating, with the computing system, the first metadata associated with the at least one metadata source as less accurately corresponding to the first video content (block 446).

Merely by way of example, in some embodiments, the identified content information might be based on at least one of logos or symbols associated with the first video content, music associated with the first video content, news personalities associated with the first video content, actors or actresses associated with the first video content, characters associated with the first video content, scenes associated with the first video content, phrases associated with the first video content, credits associated with the first video content, logos or symbols associated with a video content source associated with the first video content, music associated with the video content source associated with the first video content, news personalities associated with the video content source associated with the first video content, actors or actresses associated with the video content source associated with the first video content, characters associated with the video content source associated with the first video content, phrases associated with the video content source associated with the first video content, or credits associated with the video content source associated with the first video content, and/or the like.

### Exemplary System and Hardware Implementation

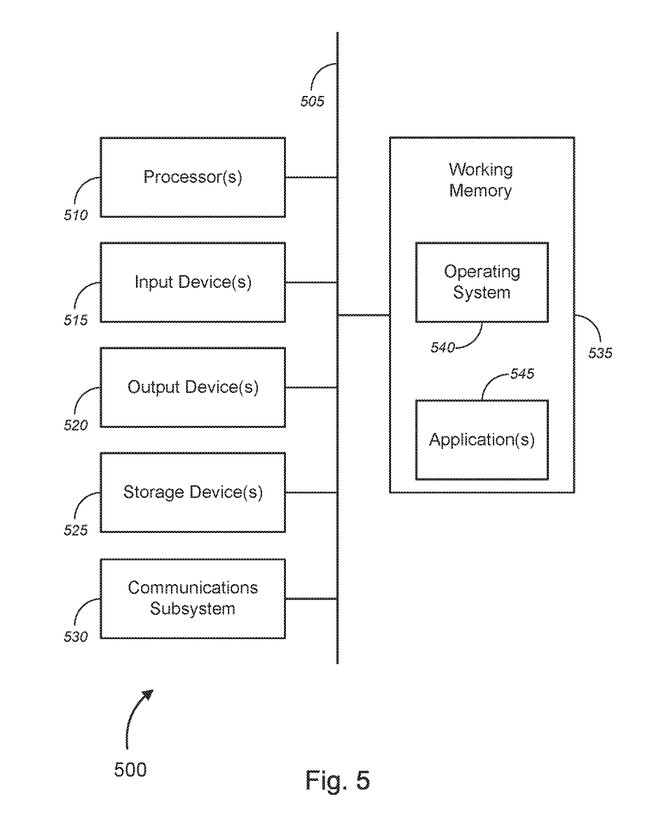

FIG. 5 is a block diagram illustrating an exemplary computer or system hardware architecture, in accordance with various embodiments. FIG. 5 provides a schematic illustration of one embodiment of a computer system 500 of the service provider system hardware that can perform the methods provided by various other embodiments, as described herein, and/or can perform the functions of computer or hardware system (i.e., computing systems 105a and 105b, (main) display devices 115, 225, and 305, user devices 120, audio playback devices 125a-125n, video content sources (or servers) 135a-135n, metadata sources (or servers) 155a-155n and 210a-210n, conflict resolution system 205, and program information and meta data processing system 220, etc.), as described above. It should be noted that FIG. 5 is meant only to provide a generalized illustration of various components, of which one or more (or none) of each may be utilized as appropriate. FIG. 5, therefore, broadly illustrates how individual system elements may be implemented in a relatively separated or relatively more integrated manner.

The computer or hardware system 500—which might represent an embodiment of the computer or hardware system (i.e., computing systems 105a and 105b, (main) display devices 115, 225, and 305, user devices 120, audio playback devices 125a-125n, video content sources (or servers) 135a-135n, metadata sources (or servers) 155a-155n and 210a-210n, conflict resolution system 205, and program information and meta data processing system 220, etc.), described above with respect to FIGS. 1-4—is shown comprising hardware elements that can be electrically coupled via a bus 505 (or may otherwise be in communication, as appropriate). The hardware elements may include one or more processors 510, including, without limitation, one or more general-purpose processors and/or one or more special-purpose processors (such as microprocessors, digital signal processing chips, graphics acceleration processors, and/or the like); one or more input devices 515, which can include, without limitation, a mouse, a keyboard, and/or the like; and one or more output devices 520, which can include, without limitation, a display device, a printer, and/or the like.

The computer or hardware system 500 may further include (and/or be in communication with) one or more storage devices 525, which can comprise, without limitation, local and/or network accessible storage, and/or can include, without limitation, a disk drive, a drive array, an optical storage device, solid-state storage device such as a random access memory (“RAM”) and/or a read-only memory (“ROM”), which can be programmable, flash-updateable, and/or the like. Such storage devices may be configured to implement any appropriate data stores, including, without limitation, various file systems, database structures, and/or the like.

The computer or hardware system 500 might also include a communications subsystem 530, which can include, without limitation, a modem, a network card (wireless or wired), an infra-red communication device, a wireless communication device and/or chipset (such as a Bluetooth™ device, an 802.11 device, a WiFi device, a WiMax device, a WWAN device, cellular communication facilities, etc.), and/or the like. The communications subsystem 530 may permit data to be exchanged with a network (such as the network described below, to name one example), with other computer or hardware systems, and/or with any other devices described herein. In many embodiments, the computer or hardware system 500 will further comprise a working memory 535, which can include a RAM or ROM device, as described above.

The computer or hardware system 500 also may comprise software elements, shown as being currently located within the working memory 535, including an operating system 540, device drivers, executable libraries, and/or other code, such as one or more application programs 545, which may comprise computer programs provided by various embodiments (including, without limitation, hypervisors, VMs, and the like), and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be encoded and/or stored on a non-transitory computer readable storage medium, such as the storage device(s) 525 described above. In some cases, the storage medium might be incorporated within a computer system, such as the system 500. In other embodiments, the storage medium might be separate from a computer system (i.e., a removable medium, such as a compact disc, etc.), and/or provided in an installation package, such that the storage medium can be used to program, configure, and/or adapt a general purpose computer with the instructions/code stored thereon. These instructions might take the form of executable code, which is executable by the computer or hardware system 500 and/or might take the form of source and/or installable code, which, upon compilation and/or installation on the computer or hardware system 500 (e.g., using any of a variety of generally available compilers, installation programs, compression/decompression utilities, etc.) then takes the form of executable code.

It will be apparent to those skilled in the art that substantial variations may be made in accordance with specific requirements. For example, customized hardware (such as programmable logic controllers, field-programmable gate arrays, application-specific integrated circuits, and/or the like) might also be used, and/or particular elements might be implemented in hardware, software (including portable software, such as applets, etc.), or both. Further, connection to other computing devices such as network input/output devices may be employed.

As mentioned above, in one aspect, some embodiments may employ a computer or hardware system (such as the computer or hardware system 500) to perform methods in accordance with various embodiments of the invention. According to a set of embodiments, some or all of the procedures of such methods are performed by the computer or hardware system 500 in response to processor 510 executing one or more sequences of one or more instructions (which might be incorporated into the operating system 540 and/or other code, such as an application program 545) contained in the working memory 535. Such instructions may be read into the working memory 535 from another computer readable medium, such as one or more of the storage device(s) 525. Merely by way of example, execution of the sequences of instructions contained in the working memory 535 might cause the processor(s) 510 to perform one or more procedures of the methods described herein.

The terms “machine readable medium” and “computer readable medium,” as used herein, refer to any medium that participates in providing data that causes a machine to operate in a specific fashion. In an embodiment implemented using the computer or hardware system 500, various computer readable media might be involved in providing instructions/code to processor(s) 510 for execution and/or might be used to store and/or carry such instructions/code (e.g., as signals). In many implementations, a computer readable medium is a non-transitory, physical, and/or tangible storage medium. In some embodiments, a computer readable medium may take many forms, including, but not limited to, non-volatile media, volatile media, or the like. Non-volatile media includes, for example, optical and/or magnetic disks, such as the storage device(s) 525. Volatile media includes, without limitation, dynamic memory, such as the working memory 535. In some alternative embodiments, a computer readable medium may take the form of transmission media, which includes, without limitation, coaxial cables, copper wire, and fiber optics, including the wires that comprise the bus 505, as well as the various components of the communication subsystem 530 (and/or the media by which the communications subsystem 530 provides communication with other devices). In an alternative set of embodiments, transmission media can also take the form of waves (including without limitation radio, acoustic, and/or light waves, such as those generated during radio-wave and infra-red data communications).

Common forms of physical and/or tangible computer readable media include, for example, a floppy disk, a flexible disk, a hard disk, magnetic tape, or any other magnetic medium, a CD-ROM, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a computer can read instructions and/or code.

Various forms of computer readable media may be involved in carrying one or more sequences of one or more instructions to the processor(s) 510 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer or hardware system 500. These signals, which might be in the form of electromagnetic signals, acoustic signals, optical signals, and/or the like, are all examples of carrier waves on which instructions can be encoded, in accordance with various embodiments of the invention.

The communications subsystem 530 (and/or components thereof) generally will receive the signals, and the bus 505 then might carry the signals (and/or the data, instructions, etc. carried by the signals) to the working memory 535, from which the processor(s) 505 retrieves and executes the instructions. The instructions received by the working memory 535 may optionally be stored on a storage device 525 either before or after execution by the processor(s) 510.

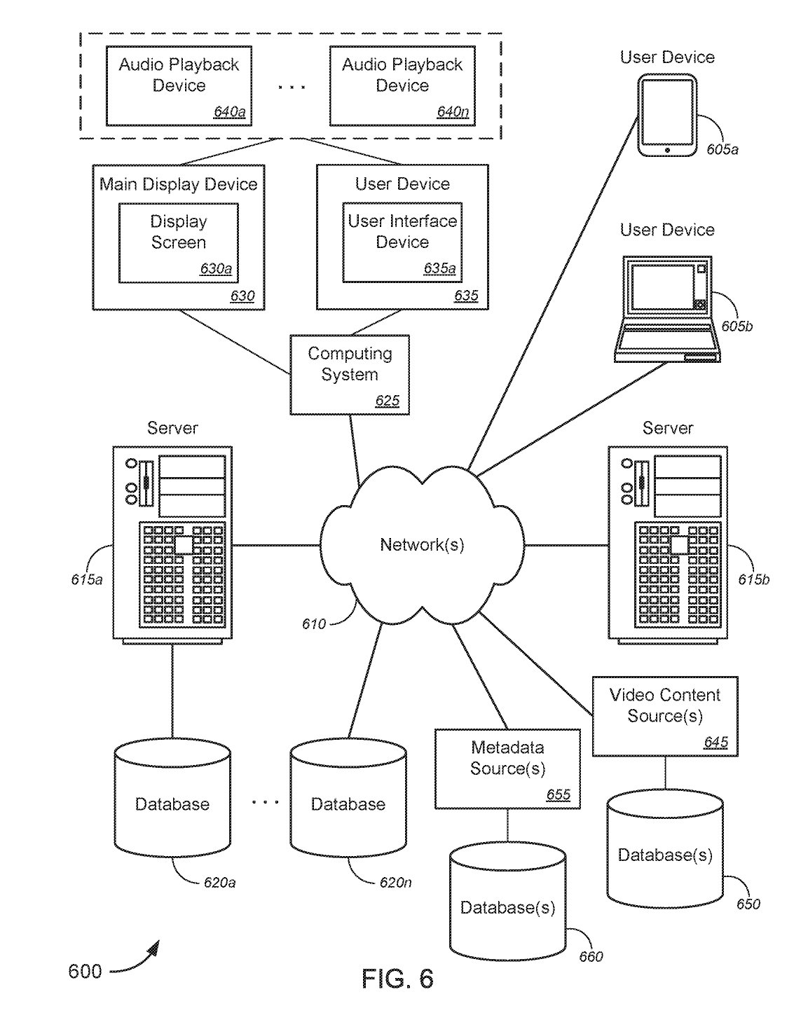

As noted above, a set of embodiments comprises methods and systems for implementing media content navigation and presentation, and, more particularly, to methods, systems, and apparatuses for implementing conflict resolution for electronic program guides. FIG. 6 illustrates a schematic diagram of a system 600 that can be used in accordance with one set of embodiments. The system 600 can include one or more user computers, user devices, or customer devices 605. A user computer, user device, or customer device 605 can be a general purpose personal computer (including, merely by way of example, desktop computers, tablet computers, laptop computers, handheld computers, and the like, running any appropriate operating system, several of which are available from vendors such as Apple, Microsoft Corp., and the like), cloud computing devices, a server(s), and/or a workstation computer(s) running any of a variety of commercially-available UNIX™ or UNIX-like operating systems. A user computer, user device, or customer device 605 can also have any of a variety of applications, including one or more applications configured to perform methods provided by various embodiments (as described above, for example), as well as one or more office applications, database client and/or server applications, and/or web browser applications. Alternatively, a user computer, user device, or customer device 605 can be any other electronic device, such as a thin-client computer, Internet-enabled mobile telephone, and/or personal digital assistant, capable of communicating via a network (e.g., the network(s) 610 described below) and/or of displaying and navigating web pages or other types of electronic documents. Although the exemplary system 600 is shown with two user computers, user devices, or customer devices 605, any number of user computers, user devices, or customer devices can be supported.

Certain embodiments operate in a networked environment, which can include a network(s) 610. The network(s) 610 can be any type of network familiar to those skilled in the art that can support data communications using any of a variety of commercially-available (and/or free or proprietary) protocols, including, without limitation, TCP/IP, SNA™, IPX™, AppleTalk™, and the like. Merely by way of example, the network(s) 610 (similar to network(s) 145 FIG. 1, or the like) can each include a local area network (“LAN”), including, without limitation, a fiber network, an Ethernet network, a Token-Ring™ network, and/or the like; a wide-area network (“WAN”); a wireless wide area network (“WWAN”); a virtual network, such as a virtual private network (“VPN”); the Internet; an intranet; an extranet; a public switched telephone network (“PSTN”); an infra-red network; a wireless network, including, without limitation, a network operating under any of the IEEE 802.11 suite of protocols, the Bluetooth™ protocol known in the art, and/or any other wireless protocol; and/or any combination of these and/or other networks. In a particular embodiment, the network might include an access network of the service provider (e.g., an Internet service provider (“ISP”)). In another embodiment, the network might include a core network of the service provider, and/or the Internet.

Embodiments can also include one or more server computers 615. Each of the server computers 615 may be configured with an operating system, including, without limitation, any of those discussed above, as well as any commercially (or freely) available server operating systems. Each of the servers 615 may also be running one or more applications, which can be configured to provide services to one or more clients 605 and/or other servers 615.

Merely by way of example, one of the servers 615 might be a data server, a web server, a cloud computing device(s), or the like, as described above. The data server might include (or be in communication with) a web server, which can be used, merely by way of example, to process requests for web pages or other electronic documents from user computers 605. The web server can also run a variety of server applications, including HTTP servers, FTP servers, CGI servers, database servers, Java servers, and the like. In some embodiments of the invention, the web server may be configured to serve web pages that can be operated within a web browser on one or more of the user computers 605 to perform methods of the invention.

The server computers 615, in some embodiments, might include one or more application servers, which can be configured with one or more applications accessible by a client running on one or more of the client computers 605 and/or other servers 615. Merely by way of example, the server(s) 615 can be one or more general purpose computers capable of executing programs or scripts in response to the user computers 605 and/or other servers 615, including, without limitation, web applications (which might, in some cases, be configured to perform methods provided by various embodiments). Merely by way of example, a web application can be implemented as one or more scripts or programs written in any suitable programming language, such as Java™, C, C#™ or C++, and/or any scripting language, such as Perl, Python, or TCL, as well as combinations of any programming and/or scripting languages. The application server(s) can also include database servers, including, without limitation, those commercially available from Oracle™, Microsoft™, Sybase™, IBM™, and the like, which can process requests from clients (including, depending on the configuration, dedicated database clients, API clients, web browsers, etc.) running on a user computer, user device, or customer device 605 and/or another server 615. In some embodiments, an application server can perform one or more of the processes for implementing media content navigation and presentation, and, more particularly, to methods, systems, and apparatuses for implementing conflict resolution for electronic program guides, as described in detail above. Data provided by an application server may be formatted as one or more web pages (comprising HTML, JavaScript, etc., for example) and/or may be forwarded to a user computer 605 via a web server (as described above, for example). Similarly, a web server might receive web page requests and/or input data from a user computer 605 and/or forward the web page requests and/or input data to an application server. In some cases, a web server may be integrated with an application server.

In accordance with further embodiments, one or more servers 615 can function as a file server and/or can include one or more of the files (e.g., application code, data files, etc.) necessary to implement various disclosed methods, incorporated by an application running on a user computer 605 and/or another server 615. Alternatively, as those skilled in the art will appreciate, a file server can include all necessary files, allowing such an application to be invoked remotely by a user computer, user device, or customer device 605 and/or server 615.

It should be noted that the functions described with respect to various servers herein (e.g., application server, database server, web server, file server, etc.) can be performed by a single server and/or a plurality of specialized servers, depending on implementation-specific needs and parameters.

In certain embodiments, the system can include one or more databases 620a-620n (collectively, “databases 620”). The location of each of the databases 620 is discretionary: merely by way of example, a database 620a might reside on a storage medium local to (and/or resident in) a server 615a (and/or a user computer, user device, or customer device 605). Alternatively, a database 620n can be remote from any or all of the computers 605, 615, so long as it can be in communication (e.g., via the network 610) with one or more of these. In a particular set of embodiments, a database 620 can reside in a storage-area network (“SAN”) familiar to those skilled in the art. (Likewise, any necessary files for performing the functions attributed to the computers 605, 615 can be stored locally on the respective computer and/or remotely, as appropriate.) In one set of embodiments, the database 620 can be a relational database, such as an Oracle database, that is adapted to store, update, and retrieve data in response to SQL-formatted commands. The database might be controlled and/or maintained by a database server, as described above, for example.

According to some embodiments, system 600 might further comprise a computing system 625, one or more main display devices 630 each with display screen 630a, one or more user devices 635 each with user interface device 635a (which in some cases might include, without limitation, a touchscreen display, a keypad, a keyboard, or other user interface devices, or the like), one or more audio playback devices 640a-640n, one or more video content sources 645 and corresponding database(s) 650, one or more metadata sources 655 and corresponding database(s) 660, and/or the like. The computing system 625, in some embodiments, might include, but is not limited to, one of an EPG system, a metadata server, a set-top box (“STB”), a digital video recording (“DVR”) device, a processor of the display device running a software application (“app”), a processor of a user device running an app, a server computer over a network, a cloud-based computing system over a network, a media player, or a gaming console, and/or the like.

In operation, the computing system 625 might comprise receiving a plurality of first metadata each from a metadata source among a plurality of metadata sources, each of the first metadata corresponding to first video content among a plurality of video content. The computing system 625 might also compile the plurality of first metadata from the plurality of metadata sources. The computing system 625 might further determine whether at least one first metadata of the plurality of first metadata is inconsistent with other first metadata of the plurality of first metadata. Based on a determination that at least one first metadata of the plurality of first metadata is inconsistent with other first metadata of the plurality of first metadata, the computing system 625 might analyze the plurality of first metadata to determine which set of first metadata more accurately corresponds to the first video content, might modify one or more of the plurality of first metadata based on which set of first metadata is determined to more accurately correspond to the first video content, might generate an electronic program guide (“EPG”) that presents the first video content in a list, using first metadata consistent with the modified one or more of the plurality of first metadata, and might display the EPG on the display screen 630a of the display device 630.

These and other functions of the system 600 (and its components) are described in greater detail above with respect to FIGS. 1-4.

While certain features and aspects have been described with respect to exemplary embodiments, one skilled in the art will recognize that numerous modifications are possible. For example, the methods and processes described herein may be implemented using hardware components, software components, and/or any combination thereof. Further, while various methods and processes described herein may be described with respect to particular structural and/or functional components for ease of description, methods provided by various embodiments are not limited to any particular structural and/or functional architecture but instead can be implemented on any suitable hardware, firmware and/or software configuration. Similarly, while certain functionality is ascribed to certain system components, unless the context dictates otherwise, this functionality can be distributed among various other system components in accordance with the several embodiments.

Moreover, while the procedures of the methods and processes described herein are described in a particular order for ease of description, unless the context dictates otherwise, various procedures may be reordered, added, and/or omitted in accordance with various embodiments. Moreover, the procedures described with respect to one method or process may be incorporated within other described methods or processes; likewise, system components described according to a particular structural architecture and/or with respect to one system may be organized in alternative structural architectures and/or incorporated within other described systems. Hence, while various embodiments are described with—or without—certain features for ease of description and to illustrate exemplary aspects of those embodiments, the various components and/or features described herein with respect to a particular embodiment can be substituted, added and/or subtracted from among other described embodiments, unless the context dictates otherwise. Consequently, although several exemplary embodiments are described above, it will be appreciated that the invention is intended to cover all modifications and equivalents within the scope of the following claims.

1. A method, comprising:
receiving, with a computing system, a plurality of metadata associated with a first video content of a plurality of video content, the plurality of metadata including a plurality of first metadata, each first metadata of the plurality of first metadata originating from a respective metadata source among a plurality of metadata sources, each of the first metadata corresponding to information regarding the first video content among the plurality of video content;
compiling, with the computing system, the plurality of first metadata from the plurality of metadata sources;
determining, with the computing system, whether at least one first metadata of the plurality of first metadata is inconsistent with other first metadata of the plurality of first metadata;
based on a determination that at least one first metadata of the plurality of first metadata is inconsistent with other first metadata of the plurality of first metadata, determining, with the computing system, that a first set of the plurality of first metadata more accurately corresponds to the first video content, wherein the first set of the plurality of first metadata includes one or more first metadata members that are consistent, wherein the first set includes more first metadata members than any other sets of the plurality of first metadata with one or more first metadata members that are consistent;
modifying, with the computing system, one or more of the plurality of first metadata to be consistent with the first set of the plurality of first metadata;
generating, with the computing system, an electronic program guide (“EPG”) that presents the information regarding the first video content based on the modified one or more of the plurality of first metadata; and
displaying, with the computing system, the EPG on a display device.

2. The method of claim 1, wherein the computing system comprises one of an EPG system, a metadata server, a set-top box (“STB”), a digital video recording (“DVR”) device, a processor of the display device running a software application (“app”), a processor of a user device running an app, a server computer over a network, a cloud-based computing system over a network, a media player, or a gaming console.

3. The method of claim 1, wherein the display device comprises one of a television set, a smart television, a computer monitor, a laptop monitor, or a projection system.

4. The method of claim 1, wherein the first video content is available from a plurality of video content sources, each comprising one of a video streaming source, a video broadcast source, an off the air (“OTA”) source, or a third party video content source.

5. The method of claim 1, wherein each of the plurality of first metadata is received by the computing system in response to one of a pull data distribution instruction, a push data distribution instruction, or a hybrid push-pull data distribution instruction.

6. The method of claim 1, wherein determining whether at least one first metadata of the plurality of first metadata is inconsistent with other first metadata of the plurality of first metadata and analyzing the plurality of first metadata to determine which set of first metadata more accurately corresponds to the first video content further comprises using at least one of a metadata provider ranking technique, a self-learning adaptive technique, an image recognition technique, an audio recognition technique, a video recognition technique, or a combination of these techniques.

7. The method of claim 1, wherein determining whether at least one first metadata of the plurality of first metadata is inconsistent with other first metadata of the plurality of first metadata and analyzing the plurality of first metadata to determine which set of first metadata more accurately corresponds to the first video content comprise:
identifying, with the computing system, which one or more portions of the plurality of first metadata are inconsistent with corresponding one or more portions of the plurality of first metadata;
determining, with the computing system, whether the identified one or more portions of the plurality of first metadata represent a majority over the corresponding one or more portions of the plurality of first metadata;
based on a determination that the identified one or more portions of the plurality of first metadata represent a majority over the corresponding one or more portions of the plurality of first metadata, designating, with the computing system, the identified one or more portions of the plurality of first metadata as more accurately corresponding to the first video content; and
based on a determination that the corresponding one or more portions of the plurality of first metadata represent a majority over the identified one or more portions of the plurality of first metadata, designating, with the computing system, the corresponding one or more portions of the plurality of first metadata as more accurately corresponding to the first video content.

8. The method of claim 1, wherein each of the plurality of first metadata comprises an accuracy counter value associated with corresponding one of the plurality of metadata sources, the accuracy counter value indicating a level of accuracy that each of the plurality of metadata sources has with respect to the first metadata, wherein determining whether at least one first metadata of the plurality of first metadata is inconsistent with other first metadata of the plurality of first metadata and analyzing the plurality of first metadata to determine which set of first metadata more accurately corresponds to the first video content comprise:
identifying, with the computing system, a metadata source among the plurality of metadata sources that is associated with the highest accuracy counter value; and
designating, with the computing system, the first metadata among the plurality of first metadata corresponding to the identified metadata source as more accurately corresponding to the first video content.

9. The method of claim 8, further comprising:
incrementing, with the computing system, the accuracy counter value of the designated first metadata corresponding to the identified metadata source as more accurately corresponding to the first video content.

10. The method of claim 8, further comprising:
decrementing, with the computing system, the accuracy counter value of first metadata corresponding to a metadata source providing first metadata deemed to be inconsistent with other first metadata of the plurality of first metadata.

11. The method of claim 8, further comprising:
determining, with the computing system, accuracy of first metadata associated with at least one metadata source of the plurality of metadata sources over a predetermined period of time;
based on a determination that the first metadata associated with the at least one metadata source is accurate for at least a predetermined threshold percentage of instances over the predetermined period of time, incrementing, with the computing system, the accuracy counter value of the first metadata associated with the at least one metadata source; and
based on a determination that the first metadata associated with the at least one metadata source is not accurate for at least the predetermined threshold percentage of instances over the predetermined period of time, decrementing, with the computing system, the accuracy counter value of the first metadata associated with the at least one metadata source.

12. The method of claim 1, wherein determining whether at least one first metadata of the plurality of first metadata is inconsistent with other first metadata of the plurality of first metadata and analyzing the plurality of first metadata to determine which set of first metadata more accurately corresponds to the first video content comprise:
analyzing, with the computing system, at least portions of the first video content using at least one of image recognition techniques, audio recognition techniques, or video recognition techniques to identify content information related to the first metadata;
determining, with the computing system, whether the first metadata associated with at least one metadata source is consistent with the identified content information;
based on a determination that the first metadata associated with the at least one metadata source is consistent with the identified content information, designating, with the computing system, the first metadata associated with the at least one metadata source as more accurately corresponding to the first video content; and
based on a determination that the first metadata associated with the at least one metadata source is not consistent with the identified content information, designating, with the computing system, the first metadata associated with the at least one metadata source as less accurately corresponding to the first video content.

13. The method of claim 12, wherein the identified content information are based on at least one of logos or symbols associated with the first video content, music associated with the first video content, news personalities associated with the first video content, actors or actresses associated with the first video content, characters associated with the first video content, scenes associated with the first video content, phrases associated with the first video content, credits associated with the first video content, logos or symbols associated with a video content source associated with the first video content, music associated with the video content source associated with the first video content, news personalities associated with the video content source associated with the first video content, actors or actresses associated with the video content source associated with the first video content, characters associated with the video content source associated with the first video content, phrases associated with the video content source associated with the first video content, or credits associated with the video content source associated with the first video content.

14. An apparatus, comprising:
at least one processor; and
a non-transitory computer readable medium communicatively coupled to the at least one processor, the non-transitory computer readable medium having stored thereon computer software comprising a set of instructions that, when executed by the at least one processor, causes the apparatus to:
receive a plurality of metadata associated with a first video content of a plurality of video content, the plurality of metadata including a plurality of first metadata, each first metadata of the plurality of first metadata originating from a respective metadata source among a plurality of metadata sources, each of the first metadata corresponding to information regarding the first video content among the plurality of video content;
compile the plurality of first metadata from the plurality of metadata sources;
determine whether at least one first metadata of the plurality of first metadata is inconsistent with other first metadata of the plurality of first metadata;
based on a determination that at least one first metadata of the plurality of first metadata is inconsistent with other first metadata of the plurality of first metadata, determine that a first set of the plurality of first metadata more accurately corresponds to the first video content, wherein the first set of the plurality of first metadata includes one or more first metadata members that are consistent, wherein the first set includes more first metadata members than any other sets of the plurality of first metadata with one or more first metadata members that are consistent;
modify one or more of the plurality of first metadata to be consistent with the first set of the plurality of first metadata;
generate an electronic program guide (“EPG”) that presents the information regarding the first video content based on the modified one or more of the plurality of first metadata; and
display the EPG on a display device.

15. The apparatus of claim 14, wherein the apparatus comprises one of an EPG system, a metadata server, a set-top box (“STB”), a digital video recording (“DVR”) device, a processor of the display device running a software application (“app”), a processor of a user device running an app, a server computer over a network, a cloud-based computing system over a network, a media player, or a gaming console.

16. The apparatus of claim 14, wherein the display device comprises one of a television set, a smart television, a computer monitor, a laptop monitor, or a projection system.

17. The apparatus of claim 14, wherein the first video content is available from a plurality of video content sources, each comprising one of a video streaming source, a video broadcast source, an off the air (“OTA”) source, or a third party video content source.

18. The apparatus of claim 14, wherein each of the plurality of first metadata is received by the computing system in response to one of a pull data distribution instruction, a push data distribution instruction, or a hybrid push-pull data distribution instruction.

19. The apparatus of claim 14, wherein determining whether at least one first metadata of the plurality of first metadata is inconsistent with other first metadata of the plurality of first metadata and analyzing the plurality of first metadata to determine which set of first metadata more accurately corresponds to the first video content further comprises using at least one of a metadata provider ranking technique, a self-learning adaptive technique, an image recognition technique, an audio recognition technique, a video recognition technique, or a combination of these techniques.

20. A system, comprising:
a computing system, comprising:
at least one first processor; and
a first non-transitory computer readable medium communicatively coupled to the at least one first processor, the first non-transitory computer readable medium having stored thereon computer software comprising a first set of instructions that, when executed by the at least one first processor, causes the computing system to:
receive a plurality of metadata associated with a first video content fo a plurality of video content, the plurality of metadata including a plurality of first metadata each first metadata of the plurality of first metadata originating from a respective metadata source among a plurality of metadata sources, each of the first metadata corresponding to information regarding the first video content among the plurality of video content;
compile the plurality of first metadata from the plurality of metadata sources;
determine whether at least one first metadata of the plurality of first metadata is inconsistent with other first metadata of the plurality of first metadata;
based on a determination that at least one first metadata of the plurality of first metadata is inconsistent with other first metadata of the plurality of first metadata, determine that a first set of the plurality of first metadata more accurately corresponds to the first video content, wherein the first set of the plurality of first metadata includes one or more first metadata members that are consistent, wherein the first set includes more first metadata members than any other sets of the plurality of first metadata with one or more first metadata members that are consistent;
modify one or more of the plurality of first metadata to be consistent with the first set of the plurality of first metadata;
generate an electronic program guide (“EPG”) that presents the information regarding the first video content based on the modified one or more of the plurality of first metadata; and
send the EPG to a display device; and
the display device, comprising:
a display screen;
at least one second processor; and
a second non-transitory computer readable medium communicatively coupled to the at least one second processor, the second non-transitory computer readable medium having stored thereon computer software comprising a second set of instructions that, when executed by the at least one second processor, causes the display device to:
receive the EPG from the computing system; and
display the EPG on the display screen.

21. The system of claim 20, wherein the computing system comprises one of an EPG system, a metadata server, a set-top box (“STB”), a digital video recording (“DVR”) device, a processor of the display device running a software application (“app”), a processor of a user device running an app, a server computer over a network, a cloud-based computing system over a network, a media player, or a gaming console.
